(19) United States
(12) Patent Application Publication
(10) Pub. No.: US 2026/0155924 A1
(43) Pub. Date: Jun. 4, 2026

(54) METHOD AND APPARATUS FOR SRS TRANSMISSION IN WIRELESS COMMUNICATION SYSTEM

(71) Applicant: Samsung Electronics Co., Ltd., Suwon-si, Gyeonggi-do (KR)

(72) Inventors: Karthik MURALIDHAR, Bangalore (IN); Diwakar SHARMA, Bangalore (IN); Dattaraj DILEEP RAUT MULGAONKAR, Bangalore (IN); Youngrok JANG, Suwon-si (KR); Hyoungju JI, Suwon-si (KR); Santanu MONDAL, Bangalore (IN)

(21) Appl. No.: 18/706,550

(22) PCT Filed: Nov. 11, 2022
(86) PCT No.: PCT/KR2022/017798

§ 371 Date: May 1, 2024

(30) Foreign Application Priority Data
Nov. 12, 2021 (IN) 202141051877
Nov. 16, 2021 (IN) 202141052557
Jan. 11, 2022 (IN) 202241001419
Aug. 24, 2022 (IN) 202241048172
Nov. 7, 2022 (IN) 2021 41051877

(51) Int. Cl. H04L 5/00; H04W 72/0453; H04W 76/27

(52) U.S. Cl. CPC H04L 5/0048; H04W 72/0453; H04W 76/27

(57) ABSTRACT

The disclosure relates to a 5G or 6G communication system for supporting a higher data transmission rate. Embodiments herein disclose a method and a base station (100) for managing sounding reference signal (SRS) transmission in a wireless communication. The method includes receiving the SRS transmitted from a group of user equipments (UEs) (200a-200d) in the wireless communication over same time-frequency resource. The method also determines the transmission variant by decoding the SRS. Further, the method includes performing one of: estimating at least one channel of receiving the SRS from each UE of the group of UEs (200a-200d) in the slot using a first receiver when the transmission variant is one of the C-CDM-C-CS variant or the V-CDM-C-CS variant, and estimating at least one channel of receiving the SRS from each UE of the group of UEs (200a-200d) in the slot using a second receiver when the transmission variant is one of the C-CDM-C-CS variant or the C-CDM-V-CS variant.

### TECHNICAL FIELD

The present disclosure relates to wireless communication, and more particularly to a method and a base station for managing SRS transmission in a wireless communication. The present application is based on, and claims priority from an Indian Provisional application No. 202141051877 filed on 12 Nov. 2021, 202141052557 filed on 16 Nov. 2021, 202241001419 filed on 11 Jan. 2022, 202241048172 filed on 24 Aug. 2022, and Indian Complete application 202141051877 filed on 7 Nov. 2022 the disclosure of which is hereby incorporated by reference herein.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHZ” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

Accordingly the embodiments herein disclose a method for managing sounding reference signal (SRS) transmission in a wireless communication. The method includes receiving, by a base station in the wireless communication, the SRS transmitted from a group of user equipments (UEs) in the wireless communication over same time-frequency resource. The method also includes determining, by the base station, the transmission variant by decoding the SRS. The transmission variant is one of a constant code division multiplexing (CDM) across SRS subcarriers and constant cyclic shift (CS)/ZC (Zadoff-Chu) code across OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across the OFDM symbol (C-CDM-V-CS) variant. Further, the method includes estimating a channel between the UE and the base station of receiving the SRS from each UE of the group of UEs in the slot using a first receiver when the transmission variant is one of the C-CDM-C-CS variant or the V-CDM-C-CS variant, or estimating the channel between the UE and the base station of receiving the SRS from each UE of the group of UEs in the slot using a second receiver when the transmission variant is one of the C-CDM-C-CS variant or the C-CDM-V-CS variant.

### Advantageous Effects of Invention

According to the embodiments of the present disclosure, the interference of SRS due to multi-transmission reception point is reduced by estimating the quality of the channel at different frequencies, and thereby increasing the capacity of SRS across different frequencies.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is a schematic view of a system for managing sounding reference signal (SRS) transmission in a wireless communication, according to the embodiments as disclosed herein;

FIG. 2A is a block diagram of a base station for managing the SRS transmission in the wireless communication, according to the embodiments as disclosed herein;

FIG. 2B is a block diagram of a user equipment (UE) for managing the SRS transmission in the wireless communication, according to the embodiments as disclosed herein;

FIG. 3 is a flow chart illustrating a method for managing the SRS transmission in the wireless communication, according to the embodiments as disclosed herein;

FIG. 4A is an example illustrating SRS time/frequency structure, according to the prior art;

FIG. 4B is an example illustrating comb-based frequency multiplexing of SRS from two different devices, according to the prior art;

FIG. 5 is an example illustrating transmission of the SRS over subcarriers, according to the prior art;

FIG. 6A is a schematic view illustrating a scenario of proposed CDM along time for Zth subcarrier, according to the embodiments as disclosed herein;

FIG. 6B is a schematic view illustrating a process for assigning resources (CDM groups/cyclic shifts) for different users during transmission of the SRS, according to the embodiments as disclosed herein;

FIG. 7 is an example illustrating a process of comb hopping across OFDM symbols, according to the embodiments as disclosed herein;

FIG. 8 is an example illustrating a time domain orthogonal cover code (TD-OCC) sequence for one user, according to the prior art;

FIG. 9 is an example illustrating the combination of TD-OCC and comb hopping, according to the embodiments as disclosed herein;

FIG. 10 is an example illustrating the combination of the TD-OCC and comb hopping with bundled orthogonal frequency-division multiplexing (OFDM) symbols, according to the embodiments as disclosed herein;

FIG. 11 is an example illustrating the combination of the TD-OCC and frequency hopping for managing the SRS transmission in the wireless communication, according to the embodiments as disclosed herein;

FIG. 12 is an example illustrating the combination of the TD-OCC and frequency hopping with bundled OFDM symbols, according to the embodiments as disclosed herein;

FIG. 13 is a schematic view illustrating SRS design principle for high mobility, according to the prior arts;

FIG. 14 is a schematic view illustrating orthogonality when a channel is changing, according to the embodiments as disclosed herein;

FIG. 15 is a schematic view illustrating multiplexing of two users on same time-frequency resources when the channel is changing, according to the embodiments as disclosed herein;

FIG. 16 is an example illustrating the multiplexing of two users on same time-frequency resources when the channel is changing, according to the embodiments as disclosed herein;

FIG. 17 is an example illustrating the transmission/repetition of same signals in a slot, according to the embodiments as disclosed herein;

FIG. 18 is an example illustrating the orthogonality over sliding windows, according to the embodiments as disclosed herein;

FIG. 19 is another example illustrating the transmission/repetition of same signals in the slot, according to the embodiments as disclosed herein;

FIG. 20 is an example illustrating the channel estimation for one user, according to the embodiments as disclosed herein;

FIG. 21 is an example illustrating the channel estimation for two users, according to the embodiments as disclosed herein;

FIGS. 22A and 22B are graphical views illustrating simulation results of the channel estimation, according to the embodiments as disclosed herein;

FIG. 23 is a graphical view illustrating curve fitting to solve Gibbs anomaly, according to the embodiments as disclosed herein;

FIG. 24 is a graphical view illustrating Slepain theory to solve the Gibbs problem, according to the embodiments as disclosed herein;

FIG. 24A-24D are graphical views illustrating the simulation results of Slepain theory to solve the Gibbs problem, according to the embodiments as disclosed herein;

FIG. 25 is a graphical view illustrating the simulation result of the channel reconstruction, according to the embodiments as disclosed herein;

FIG. 26A-26D are graphical views illustrating a comparison of existing methods and proposed method for increasing capacity of SRS, according to the embodiments as disclosed herein; and

FIG. 27A-27G are graphical views illustrating the simulation results for dependence of the Slepian on time-half bandwidth for increasing capacity of SRS, according to the embodiments as disclosed herein.

FIG. 28 is a block diagram of a configuration of a base station, according to an embodiment of the disclosure; and

FIG. 29 is a block diagram showing a structure of a terminal, according to an embodiment of the disclosure.

### BEST MODE FOR CARRYING OUT THE INVENTION

Accordingly the embodiments herein disclose a method for managing sounding reference signal (SRS) transmission in a wireless communication. The method includes receiving, by a base station in the wireless communication, the SRS transmitted from a group of user equipments (UEs) in the wireless communication over same time-frequency resource. The method also includes determining, by the base station, the transmission variant by decoding the SRS. The transmission variant is one of a constant code division multiplexing (CDM) across SRS subcarriers and constant cyclic shift (CS)/ZC (Zadoff-Chu) code across OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across the OFDM symbol (C-CDM-V-CS) variant. Further, the method includes estimating a channel between the UE and the base station of receiving the SRS from each UE of the group of UEs in the slot using a first receiver when the transmission variant is one of the C-CDM-C-CS variant or the V-CDM-C-CS variant, or estimating the channel between the UE and the base station of receiving the SRS from each UE of the group of UEs in the slot using a second receiver when the transmission variant is one of the C-CDM-C-CS variant or the C-CDM-V-CS variant.

In an embodiment, the SRS transmitted from the group of UEs over the same time-frequency resource transmitting a radio resource control (RRC) message to configure the group of UEs for transmission across the subcarriers and the OFDM symbols in designated slots where the SRS is transmitted by the group of UEs, and coding the SRS based on the RRC message. The RRC message includes at least one of a time-frequency resource allocation, a CDM code allocation, a CS code allocation, a Zadoff-Chu (ZC) code allocation, and a comb offset information.

In an embodiment, the method includes receiving, by each UE of the group of UEs, the RRC message from the base station; creating, by each UE of the group of UEs, SRS vector in each OFDM symbol based on the at least one code applied to the OFDM symbols in the designated slots; mapping, by each UE of the group of UEs, the SRS vector to an appropriate comb based on the comb offset information applied to the OFDM symbols in the designated slots; coding, by each UE of the group of UEs, the SRS based on the at least one code and the comb offset information applied to the OFDM symbols in the designated slots; and sending, by each UE of the group of UEs, the SRS in the wireless communication to the base station.

In an embodiment, the transmission variant is determined by applying, by the base station, at least one multiplexing to the OFDM symbols in the designated slots provided by the base station; separating, by the base station, the SRS transmitted by the group of UEs over same time-frequency resource based on the at least one multiplexing applied to the OFDM symbols in the designated slots provided by the base station; and determining, by the base station, at least one transmission variant from the C-CDM-C-CS variant, V-CDM-C-CS variant, or C-CDM-V-CS variant during transmission of the SRS by the group of UEs.

In an embodiment, applying, by the base station, at least one multiplexing to the OFDM symbols in the designated slot includes one of applying, by the base station, time-domain orthogonal cover code (TD-OCC) across the OFDM symbols in the designated slot; applying, by the base station, a combination of TD-OCC and frequency hopping to the OFDM symbols in the designated slot for determining interference of the at least two SRS; applying, by the base station, a combination of TD-OCC, frequency hopping and comb hopping to the OFDM symbols in the designated slot; and applying, by the base station, a combination of TD-OCC/CDM, CS/ZC code hopping and comb hopping to the OFDM symbols in the designated slot.

In an embodiment, the SRS transmitted by the group of UEs over same time-frequency resource is separated in CDM domain and then in CS domain for the C-CDM-C-CS variant and V-CDM-C-CS variant; and in CS domain and then in CDM domain for the C-CDM-C-CS variant and the C-CDM-V-CS variant.

In an embodiment, estimating at least one channel of receiving the SRS from each UE of the group of UEs in the slot using the first receiver includes: determining, by the base station, a time domain vector for each SRS subcarrier based on the comb offset information applied across the OFDM symbols in the designated slots; determining, by the base station, a CDM vector for at least one group of UE in each SRS subcarrier along the OFDM symbols in the designated slots; determining, by the base station, an effective channel vector for at least one CDM group in each SRS subcarrier based on the determined time domain vector and the determined CDM vector; determining, by the base station, CS group vector for at least one group of UE in each SRS subcarrier along the OFDM symbols in the designated slots; and estimating, by the base station, at least one channel of receiving the SRS from each UE of the group of UEs over the time-frequency resource based on the determined effective channel vector for at least one CDM group and the determined CS group vector for at least one group of UE in each SRS subcarrier.

In an embodiment, estimating at least one channel of receiving the SRS from each UE of the group of UEs in the slot using the second receiver includes: determining, by the base station, a signal vector across each SRS subcarrier in the appropriate comb of the OFDM symbols; determining, by the base station, the CS vector along each SRS subcarrier in the appropriate comb of the OFDM symbols; determining, by the base station, the effective channel vector of at least one CS group across the OFDM symbols; determining, by the base station, at least one CDM group vector across the OFDM symbols; and estimating, by the base station, at least one channel of receiving the SRS from each UE of the group of UEs over the time-frequency resource based on the determined effective channel vector of at least one CS group and the determined at least one CDM group vector across at least one OFDM symbol.

Accordingly, the embodiments herein disclose a base station for managing SRS transmission in the wireless communication. The base station includes a memory, a processor coupled to the memory, a communicator coupled to the memory and the processor, and a SRS transmission management controller coupled to the memory, the processor and the communicator. The SRS transmission management controller is configured to receive the SRS transmitted from a group of UEs in the wireless communication over same time-frequency resource. The SRS transmission management controller is configured to determine the transmission variant by decoding the SRS. The transmission variant is one of a C-CDM-C-CS variant, a V-CDM-C-CS variant, or a C-CDM-V-CS variant. Further, the SRS transmission management controller is configured to estimate a channel of receiving the SRS from each UE of the group of UEs in the slot using a first receiver when the transmission variant is one of the C-CDM-C-CS variant or the V-CDM-C-CS variant, or estimate the channel of receiving the SRS from each UE of the group of UEs in the slot using a second receiver when the transmission variant is one of the C-CDM-C-CS variant or the C-CDM-V-CS variant.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the invention thereof, and the embodiments herein include all such modifications.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In general, sounding reference signal (SRS) is transmitted on an uplink and allow a network to estimate quality of a channel at different frequencies. Considering that the SRS is transmitted on specified subcarrier, where the specified subcarrier takes values two or four (“comb-2” and “comb-4,” respectively). The SRS transmissions from different devices are frequency multiplexed within a same frequency range by assigning different combs corresponding to different frequency offsets in a slot having orthogonal frequency-division multiplexing (OFDM) symbols. For example, in case of comb-2, that is, when the SRS is transmitted on every second subcarrier, two SRS can be frequency multiplexed. In the case of comb-4, up to four SRS can be frequency multiplexed. However, the interference is enhanced during the SRS transmissions from different devices.

Code division multiplexing (CDM) is a well-known technique to increase capacity in a physical uplink control channel (PUCCH). A physical uplink shared channel (PUSCH) is used in long-term evolution (LTE) and fifth-generation (5G) technology, and consists of rows and columns of Fast Fourier transform (FFT)/Inverse-Fast Fourier transform (IFFT) matrix, and rows and columns of Hadamard matrices. However, CDM is not defined in context of SRS in conventional methods.

Further, time domain orthogonal cover code (TD-OCC) and comb hopping are two techniques considered for reducing the enhanced interference during SRS transmissions from different devices. But, until now TD-OCC is applied to same frequency region for different OFDM symbols of a user. Comb hopping for SRS is applied for different combs in different OFDM symbols. Frequency hopping uses different subbands for sounding by a user equipment (UE) in different OFDM symbols. However, TD-OCC is not combined with the comb hopping and frequency hopping for reducing the enhanced interference during SRS transmissions from different devices.

Furthermore, the SRS transmission must be performed with optimized resource allocation in the time/frequency/code/spatial/domain. When the velocity increases, denser SRS resource in time domain is required to track the channel variation in time domain. However, the conventional methods do not increase the capacity of SRS and minimize the time frequency resource at the same time. The above-mentioned issues can be addressed by the usage of CDM in context of SRS, combining TD-OCC with comb hopping and frequency hopping techniques, and in presence of Doppler.

Thus, it is desired to address the above mentioned disadvantages or other shortcomings or at least provide a useful alternative.

The principal object of the embodiments herein is to provide a method and a base station for managing sounding reference signal (SRS) transmission in a wireless communication. The method includes applying multiplexing techniques which include but not limited to code division multiplexing (CDM), time-domain orthogonal cover code (TD-OCC), frequency hopping, comb hopping and Doppler effect in combination or independently to OFDM symbols in designated slots for separating the SRS transmitted by the user equipments (UEs) over same time-frequency resource. The method also determines transmission variant during transmission of the SRS and estimates a channel of receiving the SRS from the UEs based on the determined transmission variant.

Therefore, the interference of SRS due to multi-transmission reception point is reduced by estimating the quality of the channel at different frequencies, and thereby increasing the capacity of SRS across different frequencies.

Accordingly, the embodiments herein disclose a method for managing sounding reference signal (SRS) transmission in a wireless communication. The method includes receiving, by a base station in the wireless communication, the SRS transmitted from a group of user equipments (UEs) in the wireless communication over same time-frequency resource. The method also includes determining, by the base station, the transmission variant for decoding the SRS. The transmission variant is one of a constant code division multiplexing (CDM) across SRS subcarriers and constant cyclic shift (CS) and ZC code across OFDM symbols (C-CDM-C-CS) variant, a variable CDM across the SRS subcarriers and constant CS and ZC code across the OFDM symbols (V-CDM-C-CS) variant, or a constant CDM across the SRS subcarrier and variable CS/ZC across the OFDM symbol (C-CDM-V-CS) variant. Further, the method includes estimating a channel between the UE and the base station of receiving the SRS from each UE of the group of UEs in the slot using a first receiver when the transmission variant is one of the C-CDM-C-CS variant or the V-CDM-C-CS variant, or estimating the channel between the UE and the base station of receiving the SRS from each UE of the group of UEs in the slot using a second receiver when the transmission variant is one of the C-CDM-C-CS variant or the C-CDM-V-CS variant.

Accordingly, the embodiments herein disclose a base station for managing SRS transmission in the wireless communication. The base station includes a memory, a processor coupled to the memory, a communicator coupled to the memory and the processor, and a SRS transmission management controller coupled to the memory, the processor and the communicator. The SRS transmission management controller configured to receive the SRS transmitted from a group of UEs in the wireless communication over same time-frequency resource. The SRS transmission management controller is configured to determine the transmission variant for decoding the SRS. The transmission variant is one of a C-CDM-C-CS variant, a V-CDM-C-CS variant, or a C-CDM-V-CS variant. Further, the SRS transmission management controller is configured to estimate a channel of between the UE and the base station receiving the SRS from each UE of the group of UEs in the slot using a first receiver when the transmission variant is one of the C-CDM-C-CS variant or the V-CDM-C-CS variant, or estimate the channel of receiving the SRS from each UE of the group of UEs in the slot using a second receiver when the transmission variant is one of the C-CDM-C-CS variant or the C-CDM-V-CS variant.

Conventional methods and system provide code division multiplexing (CDM) technique to increase the capacity in physical uplink control channel (PUCCH). Physical Uplink Shared Channel (PUSCH) used for long-term evolution (LTE) and fifth-generation (5G) technology includes rows and columns of fast Fourier transform (FFT) or Inverse-FFT (IFFT) matrix, and rows and columns of Hadamard matrices. However, CDM is not defined in the context of SRS in the conventional methods and system.

Conventional methods and system apply time domain orthogonal cover code (TD-OCC) to same frequency region for different OFDM symbols of a user. Comb hopping for SRS is applied to different OFDM symbols when the user equipment has different combs. Frequency hopping is used for sounding by the user equipment in different OFDM symbols. However, the conventional methods and system does not apply the combination of TD-OCC, comb hopping and frequency hopping for reducing the enhanced interference during SRS transmissions from different devices.

Unlike to the conventional methods and system, the proposed method increases the capacity of SRS by reducing the enhanced interference for SRS due to multi-transmission and reception point (TRP). The enhanced interference for SRS is reduced by separating the users/devices and estimating the channels of the separated users/devices at different frequencies. The different users/devices are separated by applying at least one multiplexing technique to the OFDM symbols in the slot. The multiplexing techniques can be applied separately or in combination with the comb hopping and the frequency hopping techniques. Further, the proposed method enhances SRS capacity in presence of Doppler. The proposed method increases the capacity/number of SRS supported and minimize the time frequency resource at the same time as the time frequency resource shares the resources with PUSCH. Orthogonality of SRS in presence of Doppler is performed to increase the SRS capacity and achieve better performance.

The proposed method includes Matlab notation followed to access matrices.

Matrix is represented by BOLD UPPERCASE, vectors by bold lowercase and scalars by normal font. A.*B is a matrix with same dimensions as A, B obtained by element-wise multiplication of A and B.

N×N FFT matrix F_{N} is defined as

$$F ( i , j ) = {e}^{- \frac{j 2 π i j}{N}} , 0 \leq i , j \leq N - 1 .$$

The ath column of F_{N} is denoted by f_{a,N}. The cyclically shifted version of fax (upward) by b positions is denoted by

$${f}_{a , N}^{( b )} .$$

The cyclically shifted version of a column vector x (upward) by b positions is denoted by x^{(b)}. x^{H} is Hermitian (conjugate transpose) of x. x^{(b)} is a vector where each element is conjugate of corresponding element of x.

Estimate of x is denoted as \hat{x}. * denotes conjugate.

Referring now to the drawings and more particularly to FIGS. 1 through 27A-27G, where similar reference characters denote corresponding features consistently throughout the figure, these are shown preferred embodiments.

FIG. 1 is a schematic view of a system (1000) for managing sounding reference signal (SRS) transmission in a wireless communication, according to the embodiments as disclosed herein.

Referring to FIG. 1, the system (1000) for managing the SRS transmission in the wireless communication includes a base station (100) and a group of UEs (200a-200d). The group of UEs (200a-200d) may be for example but not limited to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system. The group of UEs (200a-200d) transmit the SRS in the wireless communication over same time-frequency resource. The base station (100) includes but not limited to gNodeB (gNB) that provides connectivity between the group of UEs (200a-200d) and an evolved packet core (EPC). The base station (100) receives the SRS transmitted from the group of UEs (200a-200d) in the wireless communication.

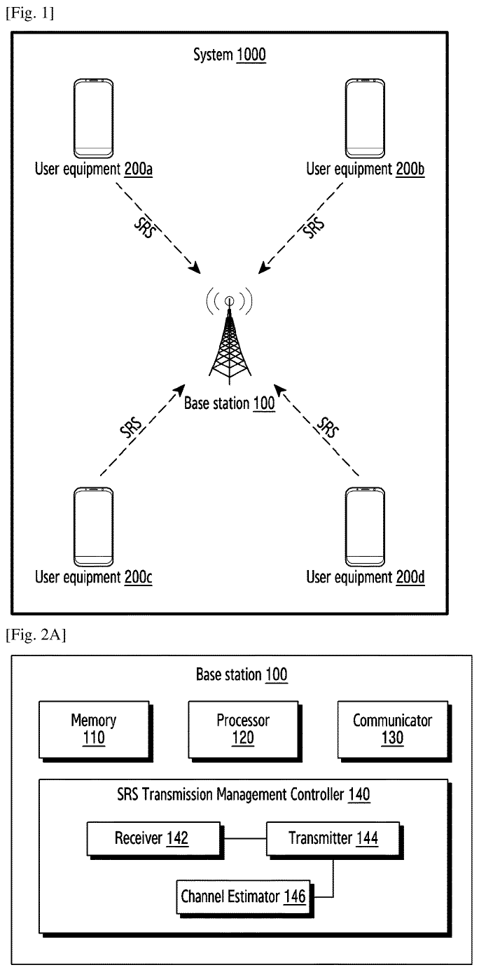

FIG. 2A is a block diagram of the base station (100) for managing the SRS transmission in the wireless communication, according to the embodiments as disclosed herein.

Referring to FIG. 2A, the base station (100) includes a memory (110), a processor (120), a communicator (130), and a SRS transmission management controller (140).

The memory (110) is configured to store the signals received by the base station (100). The memory (110) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) is configured to store larger amounts of information. In certain examples, a non-transitory storage medium may store data that can, over time, change (e.g., in Random Access Memory (RAM) or cache).

The processor (120) may include one or a plurality of processors for managing the the SRS transmission in the wireless communication. The one or the plurality of processors (120) may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (120) may include multiple cores and is configured to execute the instructions stored in the memory (110).

In an embodiment, the communicator (130) includes an electronic circuit specific to a standard that enables wired or wireless communication. The communicator (130) is configured to communicate internally between internal hardware components of the base station (100) and with external devices via one or more networks.

In an embodiment, the SRS transmission management controller (140) includes a receiver (142), a transmitter (144) and a channel estimator (146).

In an embodiment, the receiver (142) is configured to receive the SRS transmitted from the group of UEs (200a-200d) in the wireless communication over same time-frequency resource.

In an embodiment, the transmitter (144) is configured to transmit a radio resource control (RRC) message to the group of UEs (200a-200d) to transmit SRS across the subcarriers and the OFDM symbols in designated slots where the SRS is transmitted by the group of UEs (200a-200d). The RRC message includes at least one of a time-frequency resource allocation, a constant code division multiplexing (CDM) code allocation, a cyclic shift (CS) code allocation, a Zadoff-Chu (ZC) code allocation, and a comb offset information. The SRS received by the receiver (142) is coded based on the RRC message.

In an embodiment, the channel estimator (146) is configured to determine the transmission variant for decoding the SRS. The transmission variant is one of a constant code division multiplexing (CDM) across SRS subcarriers and constant cyclic shift (CS)/ZC code across OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across the OFDM symbols (C-CDM-V-CS) variant. Further, the channel estimator (146) is configured to perform one of: (i) estimating at least one channel from the UE (200a-200d) to the gNB (100) of receiving the SRS from each UE of the group of UEs (200a-200d) in the slot using a first receiver when the transmission variant is one of the C-CDM-C-CS variant or the V-CDM-C-CS variant, and (ii) estimating at least one channel from the UE (200a-200d) to the gNB (100) of receiving the SRS from each UE of the group of UEs (200a-200d) in the slot using a second receiver when the transmission variant is one of the C-CDM-C-CS variant or the C-CDM-V-CS variant.

The SRS transmission management controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/components of the SRS transmission management controller (140) may be implemented through an AI model. A function associated with the AI model may be performed through the memory (110) and the processor (120). The one or a plurality of processors (120) controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 2A show the hardware elements of the base station (100) but it is to be understood that other embodiments are not limited thereon. In other embodiments, the base station (100) may include less or more number of elements. Further, the labels or names of the elements are used only for illustrative purpose and does not limit the scope of the invention. One or more components can be combined together to perform same or substantially similar function.

FIG. 2B is a block diagram of the UE (200a-200d) for managing the SRS transmission in the wireless communication, according to the embodiments as disclosed herein.

Referring to FIG. 2B, the UE (200a-200d) includes a memory (210), a processor (220), a communicator (230) and a transceiver (240).

The memory (210) is configured to store the signals transmitted by the group of UEs (200a-200d). The memory (210) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In some examples, the memory (210) is configured to store larger amounts of information. In certain examples, a non-transitory storage medium may store data that can, over time, change (e.g., in Random Access Memory (RAM) or cache).

The processor (220) may include one or a plurality of processors for managing the SRS transmission in the wireless communication. The one or the plurality of processors (220) may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (220) may include multiple cores and is configured to execute the instructions stored in the memory (210).

In an embodiment, the communicator (230) includes an electronic circuit specific to a standard that enables wired or wireless communication. The communicator (230) is configured to communicate internally between internal hardware components of the UEs (200) and with external devices via one or more networks.

In an embodiment, the transceiver (240) is configured to receive the RRC message from the base station (100). The transceiver (240) is configured to create SRS vector in each OFDM symbol of the slot based on the code applied to the OFDM symbols in the designated slots. The SRS vector is mapped to an appropriate comb based on the comb offset information applied to the OFDM symbols in the designated slots. The SRS is coded based on the code and the comb offset information applied to the OFDM symbols in the designated slots. Further, the transceiver (240) is configured to send the SRS in the wireless communication to the base station (100).

Although the FIG. 2B show the hardware elements of the UE (200a-200d) but it is to be understood that other embodiments are not limited thereon. In other embodiments, the UE (200a-200d) may include less or more number of elements. Further, the labels or names of the elements are used only for illustrative purpose and does not limit the scope of the invention. One or more components can be combined together to perform same or substantially similar function.

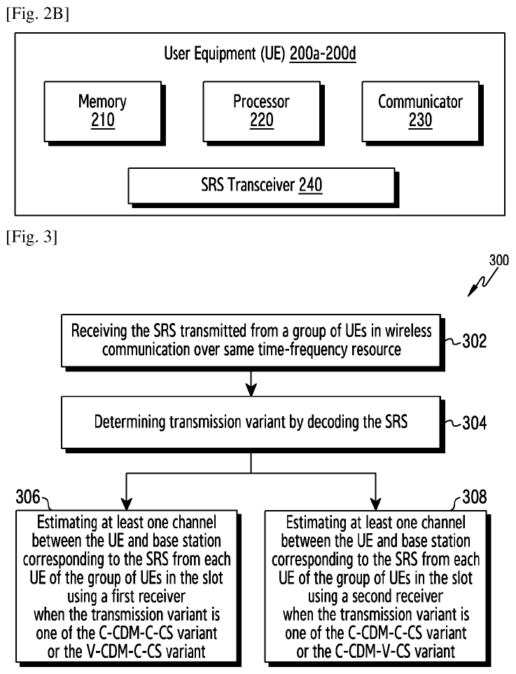

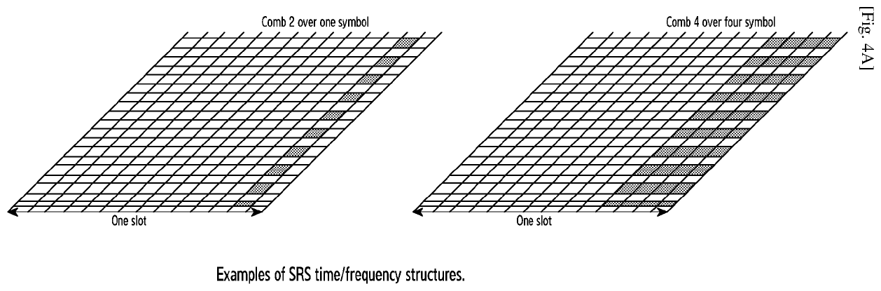

FIG. 3 is a flow chart illustrating a method (300) for managing the SRS transmission in the wireless communication, according to the embodiments as disclosed herein.

Referring to the FIG. 3, at step 302, the method includes the base station (100) receiving the SRS transmitted from the group of UEs (200a-200D) in the wireless communication over same time-frequency resource. For example, in the base station (100) as illustrated in the FIG. 1, the SRS transmission management controller (140) is configured to receive the SRS transmitted from the group of UEs (200a-200D) in the wireless communication over same time-frequency resource.

The SRS transmitted from the group of UEs (200a-200d) over the same time-frequency resource is received by the base station (100) by transmitting a radio resource control (RRC) message from the base station (100) to the group of UEs (200a-200d) that transmit across the subcarriers and the OFDM symbols in designated slots where the SRS is transmitted by the group of UEs (200a-200d), and by coding the SRS based on the RRC message. The RRC message comprises at least one of a time-frequency resource allocation, a CDM code allocation, a CS code allocation, a Zadoff-Chu (ZC) code allocation, and a comb offset information.

At step 304, the method includes the base station (100) determining the transmission variant for decoding the SRS. For example, in the base station (100) as illustrated in the FIG. 1, the SRS transmission management controller (140) is configured to determine the transmission variant for decoding the SRS. The transmission variant is one of a constant code division multiplexing (CDM) across SRS subcarriers and constant cyclic shift (CS)/ZC code across OFDM symbols (C-CDM-C-CS) variant, a variable CDM across SRS subcarriers and constant CS across OFDM symbols (V-CDM-C-CS) variant, or a constant CDM across SRSs subcarrier and variable CS/ZC code across OFDM symbols (C-CDM-V-CS) variant. The group of UEs (200a-200d) has same ZC code for the SRS when the transmission variant is the C-CDM-C-CS variant or V-CDM-C-CS variant. The group of UEs (200a-200d) has same ZC code for the SRS when the transmission variant is C-CDM-C-CS variant or the C-CDM-V-CS variant.

The transmission variant is determined by: applying at least one multiplexing to the OFDM symbols in the designated slots provided by the base station (100), separating the SRS transmitted by the group of UEs (200a-200d) over same time-frequency resource based on the at least one multiplexing technique applied to the OFDM symbols in the designated slots provided by the base station (100), and determining at least one transmission variant from the C-CDM-C-CS variant, V-CDM-C-CS variant, or C-CDM-V-CS variant during transmission of the SRS by the group of UEs (200a-200d).

The multiplexing techniques which include but not limited to CDM, time-domain orthogonal cover code (TD-OCC), comb hopping technique and frequency hopping technique, and Doppler effect can be applied separately or in combination to separate the SRS transmitted by the group of UEs (200a-200d) over same time-frequency resource.

The SRS transmitted by the group of UEs (200a-200d) is initially separated in CDM domain and then in CS domain for the C-CDM-C-CS variant and V-CDM-C-CS variant. Further, the SRS transmitted by the group of UEs (200a-200d) is initially separated in CS domain and then in CDM domain for the C-CDM-C-CS variant and the C-CDM-V-CS variant.

Considering XY UEs in the group of UEs (200a-200d) are assigned with X CDMs and Y CS/ZC codes. The group of UEs (200a-200d) is divided into X subgroups of Y UEs each. The Y UEs in each subgroup is assigned with a CDM unique to that subgroup that is same across all the SRS subcarriers. Each UE of the subgroup is assigned with one of the Y CS/ZC codes that is same across all OFDM symbols such that the UEs in the subgroup have an unique CS/ZC from the Y ZC/CS codes, where the code assignment corresponds to the C-CDM-C-CS variant.

Considering the XY UEs in the group of UEs (200a-200d) are assigned with X CDMs and Y CS/ZC codes. The group of UEs (200a-200d) is divided into X subgroups of Y UEs each. The Y UEs in each subgroup is assigned with the CDM unique to that subgroup across the given SRS subcarrier. Each UE of the subgroup is assigned with one of the Y CS/ZC codes across the plurality of OFDM symbols such that the UEs in the subgroup have a unique CS/ZC from the Y ZC/CS codes. The code assignment corresponds to the V-CDM-C-CS variant.

Considering the XY UEs in the group of UEs (200a-200d) are assigned with X CDMs and Y CS/ZC codes. The group of UEs (200a-200d) is divided into X subgroups of Y UEs each. The Y UEs in each subgroup is assigned with the CDM unique to that subgroup that is constant across all SRS subcarriers. Each UE of the subgroup is assigned with one of the Y CS/ZC codes for the given OFDM symbol such that the UEs in the subgroup have n unique CS/ZC from the Y ZC/CS codes for that given OFDM symbol. The code assignment corresponds to the C-CDM-V-CS variant.

At step 306, the method includes the base station (100) estimating at least one channel between the UE (200a-200d) and the gNB (100) corresponding to the SRS from each UE of the group of UEs (200a-200d) in the slot using a first receiver. For example, in the base station (100) as illustrated in the FIG. 1, the SRS transmission management controller (140) is configured to estimate at least one channel between the UE (200a-200d) and the gNB (100) corresponding to the SRS from each UE of the group of UEs (200a-200d) in the slot using the first receiver by: determining a received time domain vector for each SRS subcarrier based on the comb offset information applied across the OFDM symbols in the designated slots; determining a CDM vector for the ith user group in each SRS subcarrier along the OFDM symbols in the designated slots; determining an effective channel vector for the ith CDM group in each SRS subcarrier based on the determined received time domain vector and the determined CDM vector which computation is repeated for all SRS subcarriers and CDM group vectors; and computing the effective channel vector ith CDM group across all SRS subcarriers; determining all CS group vectors. And, finally the gNB (100) computes the channels of all UEs (200a-200d) to the gNB (100).

At step 308, the method includes the base station (100) estimating at least one channel between the UE (200a-200d) and the base station (100) corresponding to the SRS from each UE of the group of UEs (200a-200d) in the slot using the second receiver. For example, in the base station (100) as illustrated in the FIG. 1, the SRS transmission management controller (140) is configured to estimate at least one channel between the UE (200a-200d) and the base station (100) corresponding to the SRS from each UE of the group of UEs (200a-200d) in the slot using the second receiver by: determining a received signal vector across each SRS subcarrier in the appropriate comb of an OFDM symbol, repeating this for all OFDM symbols; determining the ith CS vector along each SRS subcarrier in the appropriate comb of an OFDM symbols, repeating for all OFDM symbols; determining the effective channel vector of ith CS group across SRS subcarriers in appropriate comb of an OFDM symbol, repeating it for all OFDM symbols; Using the preceding two computations, The base station (100) determines the effective channel vector for the ith CS group at the nth OFDM symbol. Do this for all CS groups and all OFDM symbols; the base station (100) computes the effective channel vector of the ith CS group across all OFDM symbols. The base station (100) determines the ith CDM group vector. From the preceding two computations, the channels of all the UEs (200a-200d) in the group to the base station (100) are estimated.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

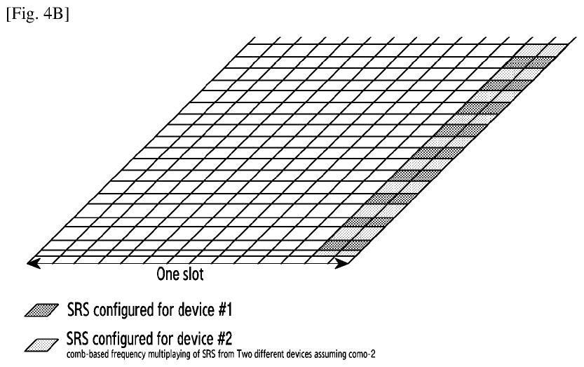

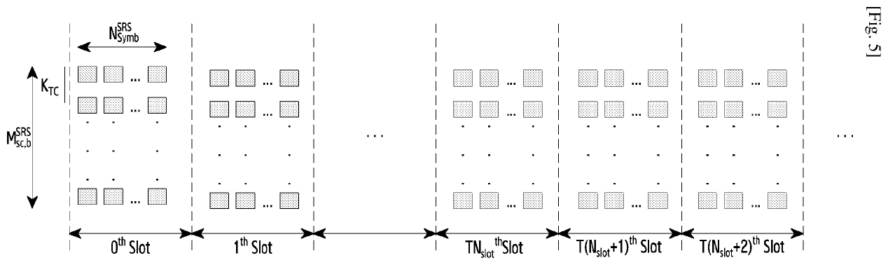

FIG. 4A is an example illustrating the SRS time/frequency structure, according to the prior art.

Referring to FIG. 4A, the SRS time/frequency structure has a plurality of slots including a set of symbols. SRS is transmitted on every KTCth subcarrier, where KTC takes the values two or four (“comb-2” and “comb-4,” respectively).

FIG. 4B is an example illustrating comb-based frequency multiplexing of SRS from two different devices, according to the prior art.

Referring to FIG. 4B, SRS transmissions from different devices can be frequency multiplexed within the same frequency range by assigning different combs corresponding to different frequency offsets. For comb-2, that is, when SRS is transmitted on every second subcarrier, two SRS can be frequency multiplexed. In the case of comb-4, up to four SRS can be frequency multiplexed.

FIG. 5 is an example illustrating the transmission of SRS over subcarriers, according to the prior art.

Referring to FIG. 5, SRS is transmitted once every K_{TC} subcarriers in a frequency domain. Each slot of the SRS time/frequency structure has

$${N}_{symb}^{srs}$$

OFDM symbols, and each OFDM symbol has a length of

$${M}_{sc , b}^{s r s}$$

subcarriers. All the

$${M}_{sc , b}^{s r s}$$

values are repeated across the

$${N}_{symb}^{srs}$$

OFDM symbols in the slot. The SRS time/frequency structure includes a configurable periodicity of T slots and SRS has the same value across slots and OFDM repetitions. The nth subcarrier value is

$${e}^{\frac{j 2 π c ( i ) n}{S ( i )}} {\overline{r}}_{u , v} ( n ; i ) ,$$

where the r̅_{u,v}(n; i) is the Zadoff-Chu sequence, c(i) is the cyclic shift for the ith port/user (denoted by

$${n}_{s r s}^{cs , i}$$

and c(i) is period of cyclic shift denoted by

$${n}_{srs}^{cs , max}$$

and can take values of 8, 12, 6 depending on K_{TC}.

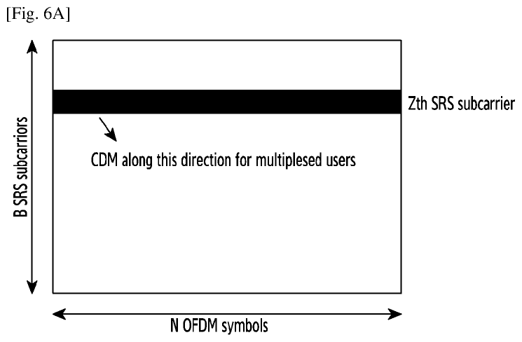

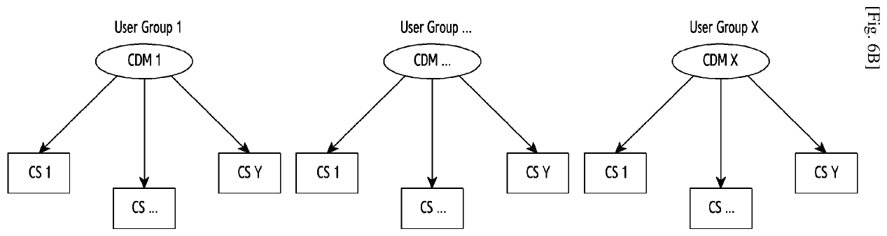

FIG. 6A is a schematic view illustrating a scenario of proposed CDM along time for the Zth SRS subcarrier, according to the embodiments as disclosed herein.

FIG. 6A shows that CDM is applied on top of the existing standard CS in frequency domain. For example, consider four users, transmitting the signal on the same subcarrier. The four users use the same time-frequency resource for the SRS. The four users have same lengths

$${M}_{sc , b}^{s r s} and {N}_{s y m b}^{s r s}$$

and overlap completely in the time and frequency region. Let

$$N {=}_{{N}_{symb}^{srs}} . {h}_{i} z$$

be the constant channel of the ith user across N OFDM symbols of a slot and B SRS subcarriers, where B is the maximum CS. The ith user transmits tᵢ(n,Z) during nth OFDM symbol 1≤n≤N and the Zth SRS subcarrier 1≤Z≤B, where n and Z are indices in the overlapped region. There are many such sets of contiguous B SRS subcarrier over which SRS is transmitted.

Here

$${t}_{i} ( n , z ) = e \frac{f 2 π c ( i ; n ) z}{B} {\overline{r}}_{u , v} ( z ; n ) {d}_{i} ( n , z )$$

is the value at the Zth SRS subcarrier in the nth OFDM symbols. r̅_{u,v}(z; n) is same for all users and could be dependent on OFDM symbol index n. If r̅_{u,v}(z; n) changes across OFDM symbols it is a case of code hopping. It is the Zadoff-Chu code with many groups u and many sequence v for each group.

Denote

$${a}_{i} ( n , z ) = e \frac{j 2 π c ( i ; n ) z}{B}$$

as the cyclic shift across B SRS subcarriers and are dependent on OFDM symbol index n for the ith user. CS index for the ith user in the nth OFDM symbol is denoted by c(i; n). The maximum CSB is same for all users. Here, dᵢ(n,z) is the CDM.

FIG. 6B is a schematic view illustrating a process for assigning resources (CDM groups/CS) for different users during transmission of SRS, according to the embodiments as disclosed herein.

Referring to FIG. 6B, in general case, if there are X CDM groups and Y cyclic shifts (CS), the XY users are supported in the same rectangular time-frequency resource of size

B×N. The resources (CDM groups/CS) are assigned as shown in FIG. 6B. Where CDM1 stands for first CDM along time and CS1 stands for first cyclic shift along frequency. FIG. 6B depicts that CDM1 and CS1 are for User 1, CDM1 and CS2 are for User 2, CDM2 and CS1 are for User 3, and CDM2 and CS2 are for User 4.

The CDM vector for the ith user group at SRS subcarrier Z along the N OFDM symbols is

$${d}_{i} {,}_{z} = [ \begin{matrix}{d}_{i} ( 0 , z ) \\ \cdot \\ {d}_{i} ( N - 1 , z )\end{matrix} ] \qquad ( 1 )$$

where, d_{i,z} is designed such that

$${d}_{j , z}^{H} {d}_{i , z} = 0 , i \neq j and {d}_{i , z}^{H} {d}_{i , z} = 1 .$$

Examples are rows/columns of Handmard and FFT matrices.

The ith CS vector along the B SRS subcarriers for the nth OFDM symbol is

$${a}_{i} {,}_{n} = [ \begin{matrix}{a}_{i} ( n , 1 ) \\ \cdot \\ {a}_{i} ( n , B )\end{matrix} ] \qquad ( 2 )$$

where,

$${a}_{j , n}^{H} {a}_{i , n} = 0 , i \neq j and {a}_{i , n}^{H} {a}_{i , n} = B$$

Three variants for the transmitter are given below:

Constant CDM across B SRS subcarriers and constant CS across N OFDM symbols, called C-CDM-C-CS, where C is constant and u,v are constant across N OFDM symbols.

Variable CDM across B SRS subcarriers and constant CS across N OFDM symbols, called V-CDM-C-CS, where V is variable and u,v are constant across N OFDM symbols.

Constant CDM across B SRS subcarriers and variable CS across N OFDM symbols, called C-CDM-V-CS, where V is variable and u,v varies across N OFDM symbols. Variation of CS across OFDM symbols is also called as CS hopping.

The proposed method involves two approaches to separate the four users for estimating the channels of the four users to the base station. In first approach, the four users are separated in CDM domain and further separated in CS domain in case of C-CDM-C-CS and V-CDM-C-CS. In second approach, the four users are first separated in CS domain and further separated in CDM domain in case of C-CDM-C-CS and C-CDM-V-CS.

During separation, any quantity is constant across N OFDM symbols and time index n is dropped. For example, a_{i,n} is represented as aᵢ and r̅_{u,v}(z; n) as r̅_{u,v}(z). Further, any quantity is constant across B subcarriers and subcarrier index z is dropped. For example, d_{i,z} is represented as dᵢ.

First approach for receiver:

Denote the received signal at nth OFDM symbol and Zth SRS subcarrier as y(n,z).

The received signal is

$$y ( n , z ) = {h}_{1} {t}_{1} ( n , z ) + {h}_{2} {t}_{2} ( n , z ) + {h}_{3} {t}_{3} ( n , z ) + {h}_{4} {t}_{4} ( n , z ) \qquad ( 3 )$$

$$y ( n , z ) = {\overline{h}}_{1 , z} {d}_{1} ( n , z ) {\overline{r}}_{u , v} ( z ) + {\overline{h}}_{2 , z} {d}_{2} ( n , z ) {\overline{r}}_{u , v} ( z ) \qquad ( 4 )$$

where the effective channels h̅_{1,z}=a₁(z)h₁+a₂(z)h₂, and h̅_{2,z}=a₁(z)h₃+a₂(z)h₄

Here h̅_{i,z} is the effective channel for the ith CDM group and the Zth SRS subcarrier, where i has value 1 for first two users and value 2 for third/fourth users.

The N×1 received vector for the Zth SRS subcarrier across the OFDM symbols is

$${Y}_{z} = [ \begin{matrix}y ( 0 , z ) \\ \cdot \\ y ( N - 1 , z )\end{matrix} ] \qquad ( 5 )$$

Received time domain vector for the Zth SRS subcarrier is

$${Y}_{z} = {\overline{h}}_{1 , z} {d}_{1 , z} {\overline{r}}_{u , v} ( z ) + {\overline{h}}_{2 , z} {d}_{2 , z} {\overline{r}}_{u , v} ( z ) \qquad ( 6 )$$

Assuming noiseless case, the effective channel vector for the ith CDM group at Zth SRS subcarrier is computed as

$$\frac{1}{{r}_{u , v} ( z )} {d}_{i , z}^{H} Y z = {\overline{h}}_{i , z} \qquad ( 7 )$$

The effective channel vector for all the SRS subcarriers 1≤Z≤B and all the CDM groups i=1,2 are computed using the above equation.

Using various h̅_{i,z} across z, the users are separated and the channels of the users are estimated in frequency domain as follows:

Let the effective channel vector for the ith CDM group across B SRS subcarriers be

$${\hat{Y}}_{i} = [ \begin{matrix}{\overline{h}}_{i , 1} \\ \cdot \\ {\overline{h}}_{i , B}\end{matrix} ] .$$

The channel of various users are computer as

$${h}_{i} = \frac{1}{B} {a}_{1}^{H} {\hat{Y}}_{1} , {h}_{2} = \frac{1}{B} {a}_{2}^{H} {\hat{Y}}_{1} , {h}_{3} = \frac{1}{B} {a}_{1}^{H} {\hat{Y}}_{2} and {h}_{4} = \frac{1}{B} {a}_{1}^{H} {\hat{Y}}_{2} ,$$

where aᵢ is the ith CS group vector.

Second approach for receiver:

The received signal is

$$y ( n , z ) = {h}_{1} {t}_{1} ( n , z ) + {h}_{2} {t}_{2} ( n , z ) + {h}_{3} {t}_{3} ( n , z ) + {h}_{4} {t}_{4} ( n , z ) \qquad ( 8 )$$

$$y ( n , z ) = {\overline{h}}_{1 , n} {a}_{1} ( n , z ) {\overline{r}}_{u , v} ( z ; n ) + {\overline{h}}_{2 , n} {a}_{2} ( n , z ) {\overline{r}}_{u , v} ( z ; n ) \qquad ( 9 )$$

where the effective channels

$${\overline{h}}_{1 , n} = {d}_{1} ( n ) {h}_{1} + {d}_{2} ( n ) {h}_{3} and {\overline{h}}_{2 , n} = {d}_{1} ( n ) {h}_{2} + {d}_{2} ( n ) {h}_{4}$$

h̅_{i,n} is the effective channel for the ith CS group and the nth OFDM symbol, where i has value 1 for first and third users and value 2 for second and fourth users.

The received signal vector across the SRS subcarriers in nth OFDM symbol is defined as

$${Y}_{n} = [ \begin{matrix}y ( n , 1 ) \\ \cdot \\ y ( n , B )\end{matrix} ] .$$

The received signal vector across the SRS subcarriers in the appropriate comb in nth OFDM symbol is

$${Y}_{n} = {\overline{h}}_{1 , n} {a}_{1 , n} {\overline{r}}_{u , ν} ( z ; n ) + {\overline{h}}_{2 , n} {a}_{2 , n} {\overline{r}}_{u , v} ( z ; n ) \qquad ( 10 )$$

Assuming noiseless case, the effective channel vector for the ith CS group at nth OFDM symbol is computed as

$$\frac{1}{{\overline{r}}_{u , v} ( z ; n )} {a}_{i , n}^{H} Y n = {\overline{h}}_{i , n} \qquad ( 11 )$$

Determine the effective channel vector for all the OFDM symbols 1≤n≤N and both CS groups i=1,2 are computed using the above equation.

Using various h̅_{i,n} across N OFDM symbols, the users are separated and the channels of the users are estimated as follows:

Let the effective channel vector for the ith CS group across N OFDM symbols be

$${\hat{Y}}_{i} = [ \begin{matrix}{\overline{h}}_{i , 1} \\ \cdot \\ {\overline{h}}_{i , N}\end{matrix} ] .$$

The channels of various users are computed as

$${h}_{1} = {d}_{1}^{H} {\hat{Y}}_{1} , {h}_{3} = {d}_{2}^{H} {\hat{Y}}_{1} , {h}_{2} = {d}_{1}^{H} {\hat{Y}}_{2} and {h}_{4} = {d}_{2}^{H} {\hat{Y}}_{2} ,$$

where dᵢ is the ith CDM group vector.

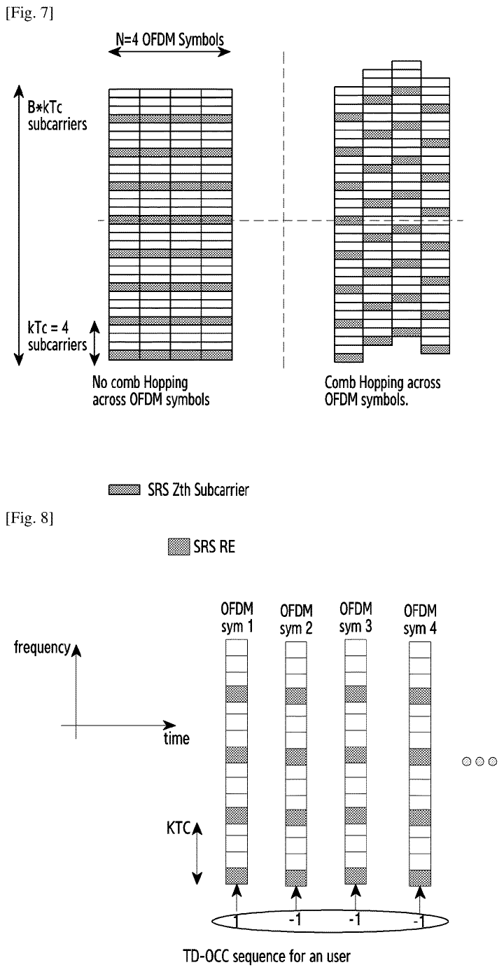

FIG. 7 is an example illustrating a process of comb hopping across the OFDM symbols, according to the embodiments as disclosed herein.

Referring to FIG. 7, the SRS also includes a hopping mode. The CDM can be extended to the hopping mode in a straightforward extension of the above principle, where CDM is applied on a per hop basis.

The values at all B SRS subcarriers for the ith user in the nth OFDM symbol is collected as the SRS vector

$${t}_{i , n} = [ \begin{matrix}{t}_{i} ( {n}_{′} 1 ) \\ \cdot \\ {t}_{i} ( {n}_{′} B )\end{matrix} ]$$

In any OFDM symbol, the SRS vector of the ith user occupies one of the kTc combs (comb offsets 0 to kTc−1) and is configured by the base station and called as comb offset information indicating which comb is in use across each of the N OFDM symbols.

The SRS vector for the ith user in nth OFDM symbol is deployed in an appropriate/configured comb for that OFDM symbol. If the comb is same across the OFDM symbols there is no comb hopping. Comb hopping is performed if the comb or the comb offset is different or varies across the OFDM symbols.

The CDM, Zadoff-Chu, CS and comb information, time-frequency resource for transmission for all user equipments and also the slot in which the SRS is transmitted are configured by the base station.

The SRS-Resource for the user in radio resource control (RRC) messages includes different fields as shown in Table 1. The CDM is applied across

$$N {=}_{{N}_{s y m b}^{s r s}}$$

OFDM symbols in each hop if frequency hopping is enabled. One can have a different CDM for each subcarrier per user as well. But to reduce overhead, assume same CDM across all subcarriers of a user.

| Field | Description |
|---|---|
| Integer | 0, 1, . . . Etc. 0: Hadamard table, 1: FFT table. |
| orthogonal_table | Table is of dimension N × N, where N is defined as |
| | srs-resource.resourcemapping.nrOfSymbols{n1, n2, |
| | n4} |
| Integer | Index of the row in the orthogonal_table. To be |
| cdm_index | used as CDM (code division multiplex). Varies |
| | from 0, . . . , N − 1. (index starts from zero). |

FIG. 8 is an example illustrating the TD-OCC sequence for one user, according to the prior art.

Referring to FIG. 8, TD-OCC is applied to same frequency region for different OFDM symbols in the slot of the user equipment. A specific value is mapped to each OFDM symbol of the slot. Each value is used to modify all the SRS resource elements (REs) in that OFDM symbol.

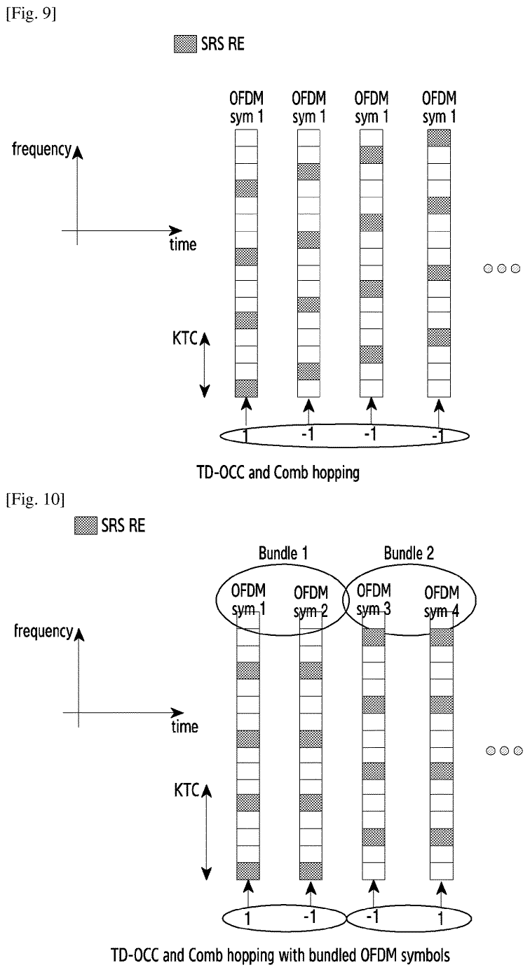

FIG. 9 is an example illustrating the combination of TD-OCC and comb hopping techniques, according to the embodiments as disclosed herein.

Referring to FIG. 9, TD-OCC is combined with comb hopping to deal with enhanced interference in SRS for multiple-transmission reception point (mTRP). Generally, channel does not change much across KTC subcarriers and hence TD-OCC with comb-hopping will not result in much performance loss compared to conventional TD-OCC without comb hopping. An example TD-OCC sequence for the user is depicted, where the values mapped to the OFDM symbols are used to modify all SRS REs in that OFDM symbol.

FIG. 10 is an example illustrating the combination of TD-OCC and comb hopping with bundled OFDM symbols, according to the embodiments as disclosed herein.

FIG. 10 shows an example illustrating the TD-OCC sequence of length 2 per bundle for one user, where each bundle includes two or more OFDM symbols. Specific values are mapped to each OFDM symbol of the bundle. The mapped values are used to modify all the SRS REs in that OFDM symbol. Each bundle has two or more OFDM symbols and has its own TD-OCC (length two here). The bundles perform comb hopping when the user has different combs in different OFDM symbols.

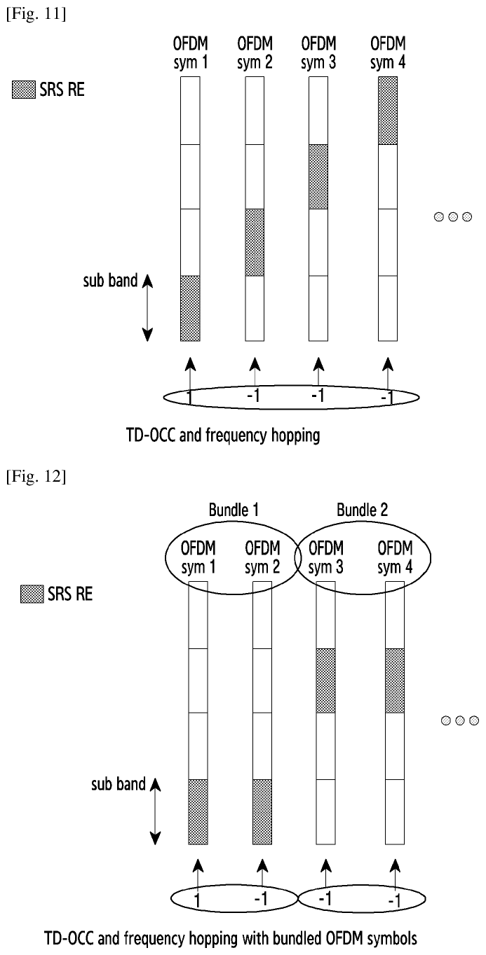

FIG. 11 is an example illustrating the combination of TD-OCC and frequency hopping, according to the embodiments as disclosed herein.

FIG. 11 depicts the example where TD-OCC and frequency hopping are combined for channel estimation across all frequencies. TD-OCC sequence for the user is shown, where the TD-OCC sequence includes OFDM symbols with a plurality of subbands. In regard to a receiver, each subband corresponds to same set of multi-paths (delays) in time domain. In such case, the users are separated by applying TD-OCC in combination with frequency hopping to the OFDM symbols in delay domain. Once the time domain multipath is estimated, channel across all frequencies is estimated.

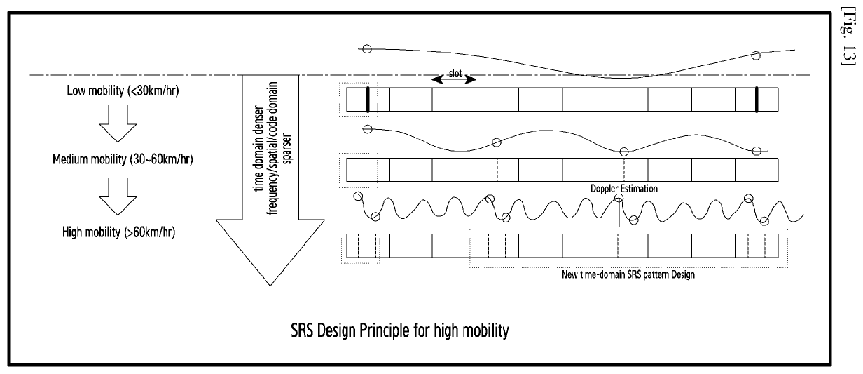

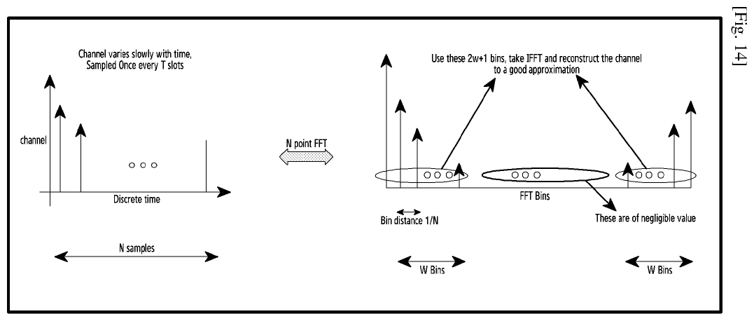

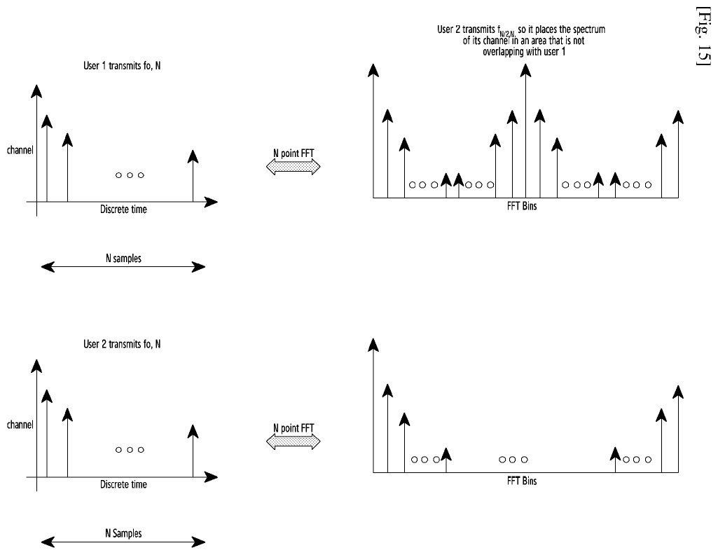

FIG. 12 is an example illustrating the combination of TD-OCC and frequency hopping with bundled OFDM symbols, according to the embodiments as disclosed herein.

FIG. 12 depicts the example TD-OCC sequence of length 2 per bundle for the user, where each bundle includes two or more OFDM symbols. Specific values are mapped to each OFDM symbol, and the mapped values are used to multiply all SRS REs in that OFDM symbol. Each bundle has its own TD-OCC (length two here). The bundles perform frequency hopping in combination with TD-OCC, when each bundle has the same frequency domain region for channel estimation.

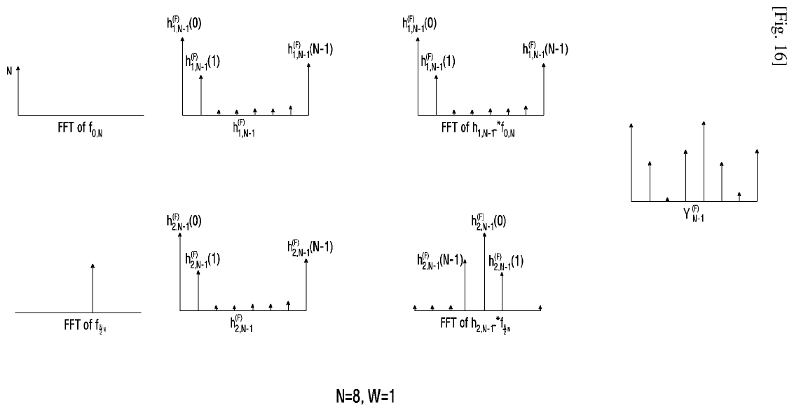

FIG. 13 is a schematic view illustrating the SRS design principle for high mobility, according to the prior arts.

Referring to the FIG. 13, SRS design principle for high mobility in conventional methods and systems is illustrated.

To increase the capacity/number of SRS supported and to minimize the time frequency resource at the same time as the time frequency resource shares resources with PUSCH, new SRS design should be considered with optimized resource allocation in the time/frequency/code/spatial/domain. When the velocity increases, denser SRS resource in time domain is required to better track the channel variation in time domain. Consequently, to maintain nearly the same overall SRS resource while guarantee the channel estimation accuracy, one can either make each SRS sparser in the frequency domain based on the sparse characteristic of multi-path channel, or producing additional orthogonal SRSs with zero auto/cross correlation properties over the same frequency resources in the code domain, or adopt beam-formed SRS transmission to accommodate more SRS in the spatial domain. For example, as shown in the FIG. 13, the density of SRS in time domain is required to increase by 4 times as the velocity increases, and then the density of SRS in frequency domain can be reduced to ¼ of original density to keep the overall overhead not to increase.

Furthermore, the SRS periodicity should be reduced to below 2.5 ms for velocity larger than 60 km/h to guarantee channel variation tracking in time domain. However, current Time Division Duplex (TDD) frame structure only supports minimum SRS periodicity with 5 slots which is 2.5 ms (30 KHz subcarrier spacing). The reason is that there is no Uplink (UL) slot in the middle of two SRS slots with 2.5 ms periodicity. Therefore, new SRS pattern design should be considered to support denser SRS transmission in time domain for velocity larger than 60 km/h.

Orthogonality of SRS in presence of Doppler (time domain or across OFDM symbols/slots), and orthogonality in changing channel conditions over observations interval has to be ensured. Conventionally, orthogonality over an observation window means channel(s) are constant over that observation window. Orthogonality over a siding window, as window sides over new observation samples has to be performed. This means the codes used for orthogonality among users are orthogonal when cyclically shifted. Orthogonality of SRS in presence of Doppler is performed to increase the SRS capacity and achieve better performance.

Consider two users, transmitting a signal on the same subcarrier in the OFDM symbol once every T slots. Consider N such time instances and Doppler is zero. The two users use the same time frequency resource. hᵢ be the constant channel (Doppler=0) of the ith users across nth time instant. The ith user transmits tᵢ(n) during nth time instant. Denote the received signal at nth time instant as y(n). The N×1 received vector at the (N−1)st time instant is

$${Y}_{n - 1} = [ \begin{matrix}y ( 0 ) \\ \cdot \\ y ( N - 1 )\end{matrix} ]$$

The N×1 vector of transmitted values by the ith user at time instant N−1 is

$${p}_{i , N - 1} = [ \begin{matrix}{t}_{i} ( 0 ) \\ \cdot \\ {t}_{i} ( N - 1 )\end{matrix} ]$$

The received signal is determined by

$${Y}_{N - 1} = {h}_{1} {p}_{1 , N - 1} + {h}_{2} {p}_{2 , N - 1} \qquad ( 12 )$$

Assuming a noiseless case for simplicity, select p_{1,N-1} and p_{2,N-1} as being orthogonal i.e.

$${p}_{{1}^{N - 1}}^{H} {p}_{2 , N - 1} = 0 .$$

Furthermore, assume

$${ρ}_{i , N - 1}^{H} {ρ}_{i , N - 1} = 1.$$

Therefore, estimates of the channel of users is

$${\hat{h}}_{i} = {ρ}_{i , N - 1}^{H} {Y}_{N - 1} .$$

However, conventional orthogonality design fails in changing channel conditions—Third Generation Partnership Project (3GPP) orthogonality designs assume that channel is constant over the observation. If channel changes within the observation of N samples then conventional orthogonality designs fail.

FIG. 14 is a schematic view illustrating the orthogonality when the channel is changing, according to the embodiments as disclosed herein.

FIG. 14 illustrates a scenario where the channel(s) of the UEs (200a-200d) changes and the process for ensuring near-orthogonality. Orthogonality is ensured when the channel is changing. The changing channel is a low pass signal as the changing channel slowly varies across time due to Doppler and is captured by low-pass FFT bins. IFFT is applied and the channels are reconstructed to a good approximation using the FFT bins.

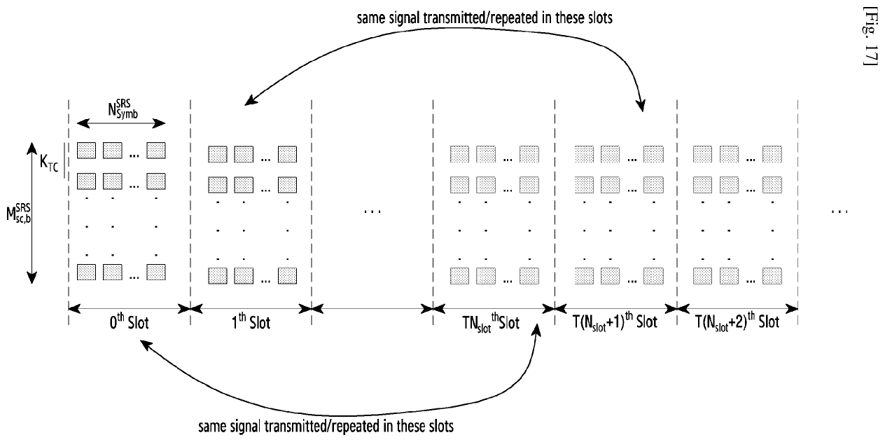

FIG. 15 is a schematic view illustrating the multiplexing of two users on same time-frequency resources when the channel is changing, according to the embodiments as disclosed herein.

FIG. 15 illustrates a scenario how the users can multiplexed on same time frequency resources when the channel is changing. Consider user 1 transmits f_{0,N} and user 2 transmits f_{N/2,N}, such that the spectrum of user 2 channel is placed in an area that is not overlapping with the user 1. The users can be multiplexed on same time frequency resources only if

$$2 w + 1 \leq \frac{N}{2} .$$

In general,

$$[ \frac{N}{2 w + 1} ]$$

users can be multiplexed over the same time-frequency resource, if each user transmits f_{0,n},f_{2w+1,N} . . . over the N samples.

As known that

$${Y}_{n - 1} = [ \begin{matrix}y ( 0 ) \\ \cdot \\ y ( N - 1 )\end{matrix} ] , pi , N - 1 = [ \begin{matrix}{t}_{i} ( 0 ) \\ \cdot \\ {t}_{i} ( N - 1 )\end{matrix} ] .$$

Assume that transmission has periodicity of N slots i.e. tᵢ(a+N)=tᵢ(a), 0≤a≤N−1. The channel vector at time instant n is defined as (for the ith user).

$${h}_{i , n} = [ \begin{matrix}{h}_{i , n - N + 1} \\ ⋮ \\ {h}_{i , n}\end{matrix} ] .$$

Where h_{i,n} is the ith user's channel during the nth sampling instant (one sample every T slots and on a given subcarrier for both users). Further assuming that, p_{1,N-1}=f_{0,N} and p_{2,N-1}=f_{N/2},N and the channels are such that

$$2 w + 1 \leq \frac{N}{2} .$$

The equations are

$${Y}_{N - 1} = {h}_{1 , N - 1 \cdot } * {f}_{0 , N} + {h}_{2 , N - 1 \cdot } * {f}_{\frac{N}{2} , N}$$

Note that both h_{1,N-1} and h_{2,N-1} are characterized by 2 W+1 FFT bins. Let the FFT of h_{i,N-1} be denoted by

$${h}_{i , N - 1}^{( F )}$$

and its ath element be

$${h}_{N - 1}^{( F )} ( a ) .$$

An approximate estimate of h_{i,N-1} is

$${\hat{h}}_{\dot{i} , N - 1} = \frac{1}{N} {Σ}_{k = - w}^{w} {h}_{i , N - 1}^{( F )} ( k mod N ) {f}_{kmodN , N}^{*} . \qquad ( 13 )$$

Let the FFT of Yₙ₋₁ be denoted as

$${Y}_{N - 1}^{( F )}$$

and its ath element be

$${Y}_{N - 1}^{( F )} ( a ) .$$

The channels of the users over the N samples is constructed as

$${\hat{h}}_{\dot{1} , N - 1} = \frac{1}{N} {Σ}_{k = - w}^{w} {y}_{N - 1}^{( F )} ( k mod N ) {f}_{kmodN , N}^{*} \qquad ( 14 )$$

$$and$$

$${\hat{h}}_{\dot{2 ,} N - 1} = \frac{1}{N} {Σ}_{k = - w}^{w} {y}_{N - 1}^{( F )} ( ( \frac{N}{2} + k ) mod N ) {f}_{kmodN , N}^{*} \qquad ( 15 )$$

which is straight forward extension to greater than two users.

FIG. 16 is an example illustrating the multiplexing of two users on same time-frequency resources when the channel is changing, according to the embodiments as disclosed herein.

FIG. 16 depicts the scenario of how two multiplexed users can be separated in changing channel conditions. The two multiplexed users can be separated in changing channel conditions using the equations expressed under FIG. 15.

FIG. 17 is an example illustrating the transmission/repetition of same signals in the slot, according to the embodiments as disclosed herein.

FIG. 17 illustrates that the transmitted signal is periodic with periodicity N=Nslots. Assuming that the transmission has periodicity of N slots, i.e. tᵢ(a)=tᵢ(N+a), 0≤a≤N−1.

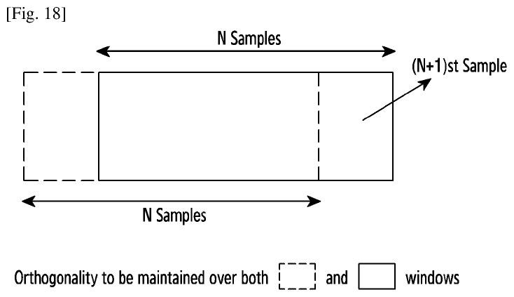

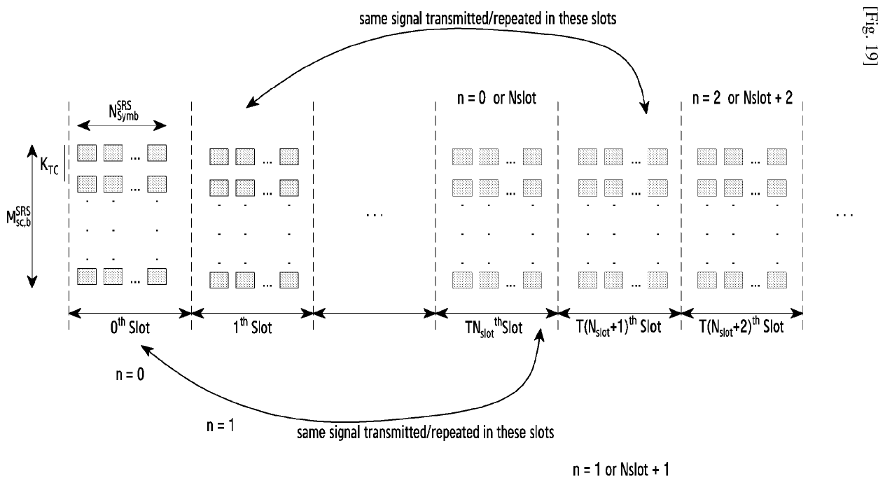

FIG. 18 is an example illustrating the orthogonality over sliding windows, according to the embodiments as disclosed herein.

Referring to FIG. 18, orthogonality is maintained over sliding windows and changing channel conditions. Consider a scenario illustrating orthogonality over sliding windows. If two (or more) users, transmitting in the same time-frequency resource, the channels of the users has to be estimated, by requiring at least N samples. However, when the Nth sample arrives, the two channels of the two users at the Nth instant are estimated only by using the past (N−1) samples. So that the orthogonality proposed is valid over the sliding window of N samples, the window slides by one sample as every sample is received. Orthogonality is preserved as the window slides by one sample at a time, for N such slides, when it reaches the (2N−1)th sample.

Since rows (columns) of FFT (IFFT) matrix are used by the users as transmitting symbols, and for any two rows (columns) of FFT (IFFT) matrix, any cyclically shifted version of the row (column) of the FFT (IFFT) matrix is orthogonal to any cyclically shifted version of another row (column) of the FFT (IFFT) matrix. The sliding window has to preserve the orthogonality to estimate the channels of both users, when the window slides by one sample to accommodate a new sample.

In the proposed method, considering two windows where the first window covers 0 to (N−1) samples and the second window covers the ath sample to (a+N−1) st sample.

The first window is estimated as

$${Y}_{N - 1} = {h}_{1 , N - 1 \cdot } * {f}_{0 , N} + {h}_{2 , N - 1 \cdot } * {f}_{\frac{N}{2} , N} . \qquad ( 16 )$$

Note that the FFT of h_{1,N-1}.*f_{0,N} occupies bins 0, . . . w and bins N−w . . . , N−1, while the FFT of

$${h}_{2 , N - 1 \cdot } * {f}_{\frac{N}{2} , N} .$$

occupies bins N/2−w, . . . N/2+w. Since

$$2 w + 1 \leq \frac{N}{2} . ,$$

FFT of h_{1,N-1}.*f_{0,N} and

$${h}_{2 , N - 1 \cdot } * {f}_{\frac{N}{2} , N}$$

are well separated in FFT domain and both user's channels are recovered in first window.

The second window is estimated as

$${Y}_{a + N - 1} = {h}_{1 , a + N - 1 \cdot } * {f}_{0 , N}^{( a )} + {h}_{2 , N - 1 \cdot } * {f}_{N / 2 , N}^{( a )} . \qquad ( 17 )$$

The FFT matrix property results in

$${f}_{0 , N}^{( a )} = {e}^{- \frac{j 2 π 0 a}{N}} {f}_{0 , N} and {f}_{N / 2 , N}^{( a )} = {{e}^{}}^{- \frac{j 2 π ( \frac{N}{2} ) a}{N}} {f}_{N / 2 , N} .$$

The second window is estimated as

$${Y}_{a + N - 1} = {e}^{- \frac{j 2 π 0 a}{N}} {h}_{1 , a + N - 1} . * {f}_{0 , N} + {e}^{- \frac{j 2 π ( \frac{N}{2} ) a}{N}} {h}_{2 , N - 1} . * {f}_{N / 2 , N} \qquad ( 18 )$$

which is exactly the same as the first window except for scalars

$${e}^{- \frac{j 2 π 0 a}{N}} and {e}^{- \frac{j 2 π ( \frac{N}{2} ) a .}{N}}$$

Therefore, the channel of both users is estimated from time instants a to a+N−1. But more importantly, the channels of both users at time instant a+N−1 which is the new sample consumed by the sliding window has to be estimated. As the sliding window moves by one sample, the channels of both users at that sample can be estimated.

FIG. 19 is another example illustrating the transmission/repetition of same signals in the slot, according to the embodiments as disclosed herein.

Referring to the FIG. 19, each black square shown in the FIG. 18 is the SRS waveform. The proposed waveform change is to modify all the SRS symbols in the nTth slot with

$${e}^{- \frac{j 2 π an}{Nslot}} , 0 \leq a \leq Nslot - 1.$$

Here ar is user and subcarrier dependent or just user dependent and same across subcarriers.

Those skilled in the art can easily have variants of the proposed wave forms. For two users the exponential multiplication that is slot dependent can be the same, however all the

$${N}_{symb}^{srs}$$

of each user across time in the given subcarrier in the given slot can be covered by the CDM (that is user dependent, slot dependent and subcarrier dependent) to separate the users. The CDM can be FFT/IFFT rows are rows of Handmard matrix.

The ith symbol of each user in the slot forms a sequence called as the ith sequence. The ith sequence of Nₛₗₒₜₛ elements are multiplied element wise by

$${e}^{- \frac{j 2 π an}{Nslot}} , 0 \leq a \leq N - 1$$

where a is dependent, and different, on sequency index i and user index u. Any variants of the above are quite straightforward to those skilled in the art and will be considered to be covered in the proposed method.

Two users are time multiplexed over the slot. Compared to existing standard, the proposed method can have any linear combination of two users in the same time-frequency resources. The two users have the same comb, cyclic shift, etc., and the weights in time domain (that determines the linear combination).

In any OFDM symbol in any slot and any subcarrier, a*x is transmitted by the user equipment, where x is the transmission based on existing standard for that user equipment and a is the additional scaling for that user equipment. Similarly for a second user equipment, in any OFDM symbol in any slot and any subcarrier, b*y is transmitted by the second user equipment, where y is the transmission based on existing standard for that user equipment and bis the additional scaling for that user equipment. For two multiplexed users, ax+by+n is received at the receiver for that OFDM symbol in that slot and subcarrier, where n is noise and a can be equal or not equal to b. Same can be extended for multiple user equipments.

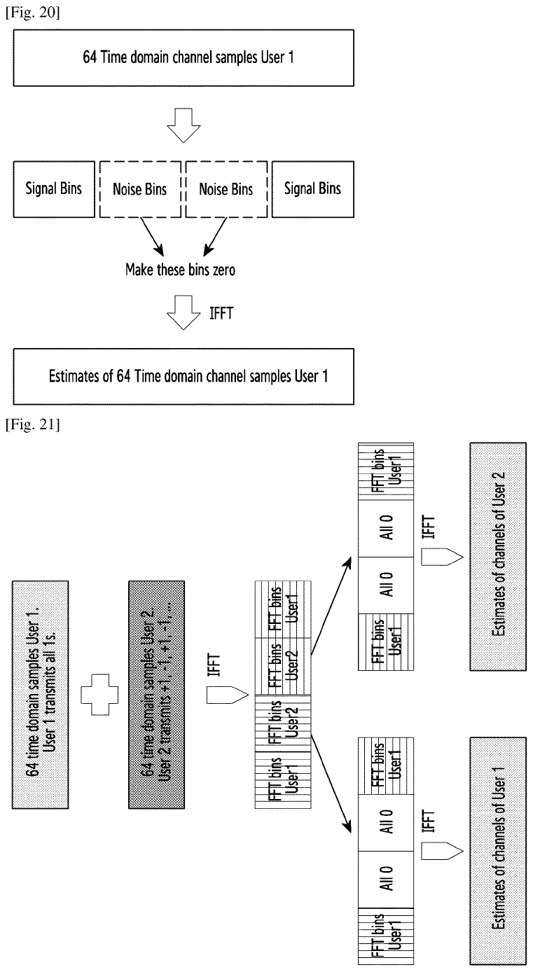

FIG. 20 is an example illustrating the channel estimation for one user, according to the embodiments as disclosed herein.

Assuming that the sampled channel is in time. The channel is further assumed to be constant over w samples. Sampling period is T₁ (time between two samples). The quantity w depends on Doppler frequency or sampling frequency or coherence time or speed of the user equipment. By averaging over w samples, the proposed SRS design/method can improve the Signal-to-noise ratio (SNR) by 10*log 10(w).However, for optimal resource utilization, one can sample at a reduced sampling rate of wT₁ (time between two samples). Two adjacent samples are no longer the same, so averaging does not improve SNR. In this case, the SNR can be improved as illustrated in FIGS. 18 and 19.

Referring to FIG. 20, by time-domain samples, the channel is estimated in the frequency domain (at a given subcarrier) collected across time (OFDM symbols/slots or different SRS occasions in time). As an example, consider a block of 64 samples of the channel. The FFT has a bandwidth of 0.25 (digital frequency scale is 0-1). Denoising technique is used to filter the frequency domain channel. The proposed SRS design/method use denoising technique in the context of the time-domain. If the channel bandwidth is B, SNR gain is

$$10 * log 10 ( \frac{1}{2 B} ) .$$

FIG. 21 is an example illustrating the channel estimation for two users, according to the embodiments as disclosed herein.

Referring to FIG. 21, two users can transmit SRS in such a way that the FFT bins do not overlap. Thereby, increasing the capacity of SRS and SNR. But, the problem occurred in the frequency domain is PUSCH DeModulation Reference Signal (DMRS) for multiple users, and Gibbs phenomenon.

In Doppler Scenario, more frequent SRS are transmitted and the resources are eaten up. To reduce resources consumed by SRS, to deal with the Gibbs phenomenon, CDM or OCC cannot be applied to the conventional receiver for SRS occasions in the time domain. Therefore, the proposed method uses Discrete Prolate Spheroidal Sequences (DPSS) or Slepian sequences in the receiver instead of conventional IFFT to overcome the Gibbs phenomenon. These sequences are specially designed to address spectral leakage or Gibbs phenomenon.

Therefore, the proposed method shows 2× (200%) increased SRS capacity (high Doppler) and 4× (400%) increased SRS capacity (low Doppler) at better performances compared to existing SRS.

The proposed method maintains and ensures orthogonality of SRS in presence of Doppler (time-domain or across OFDM symbols/slots), and orthogonality in changing channel conditions over the observation interval. Conventionally orthogonality over the observation window means that the channel(s) are constant over that observation window. Concepts are similar to Orthogonal Time Frequency Space (OTFS). Orthogonality over the sliding window, like the window slides over new observation samples. This means the codes used for orthogonality among users should still be orthogonal when cyclically shifted. The Slepian sequence could be used in a conventional/existing LTE receiver for multi-user PUSCH/SRS for better performance or SRS in 5G, in frequency domain, and commercially implemented in the base station products.

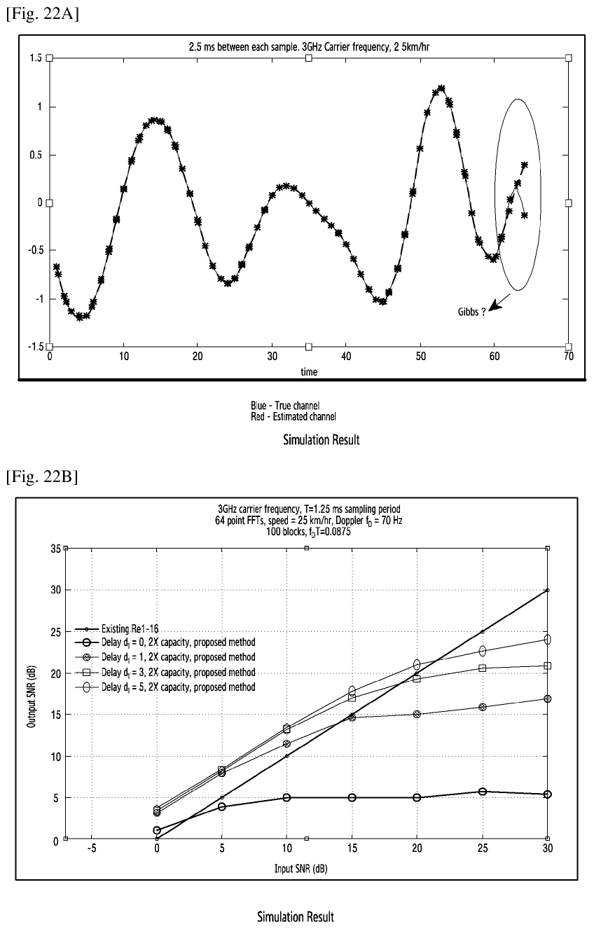

FIGS. 22A and 22B are graphical views illustrating the simulation results of the channel estimation, according to the embodiments as disclosed herein.

FIG. 22A illustrates at any instant n, past 63 samples and FFT are obtained, 32 FFT bins are selected and 64-point IFFT is applied to reconstruct the channel at n and past 63 instants. The channel at time n has a problem at the edge. In the middle for the instant at n-delay where delay=6, as an example, the channel is almost perfect. SNR=50 Db, when two or more users transmit SRS across one subcarrier over many OFDM symbols/slots.

FIG. 22B illustrates at time instant n, the channels at n, n−1, . . . , n−63 (assuming a block length of 64) are estimated. The channel estimation error decreases as the Gibbs effect decreases, when moved away from the edge (n). A delay d₁ is determined by estimating the channel estimation error of the channel d₁ samples away from the edge at time instant n. As moved away from the edge, the SNR output is increased with respect to the existing standard and the SNS capacity is also increased by two times to solve the Gibbs phenomenon.

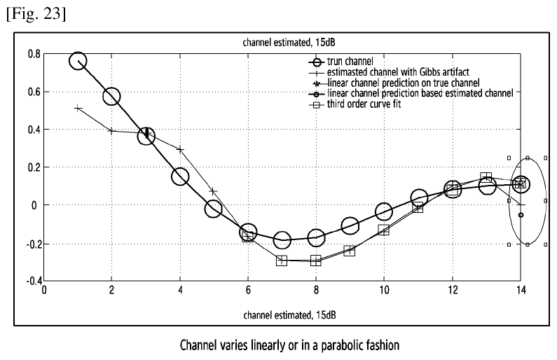

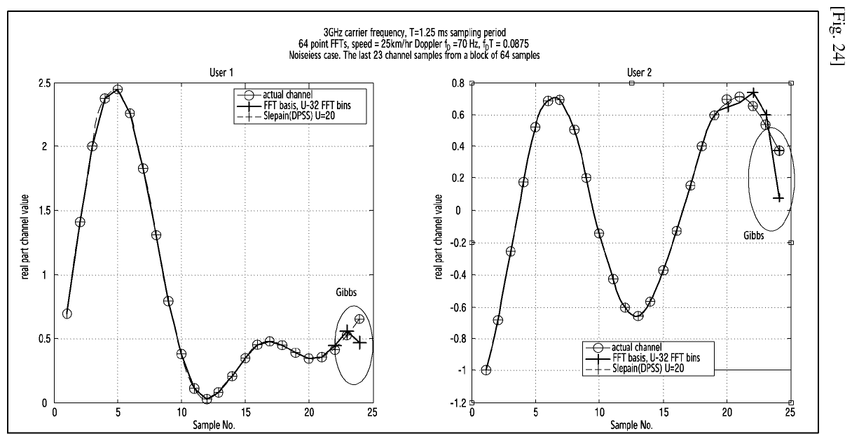

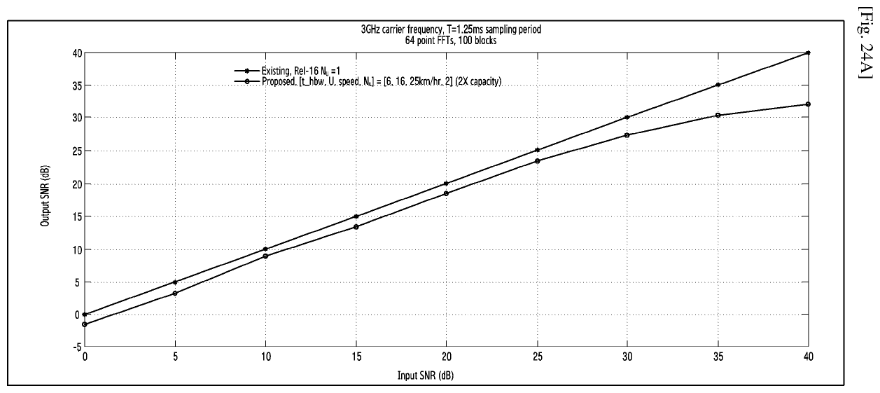

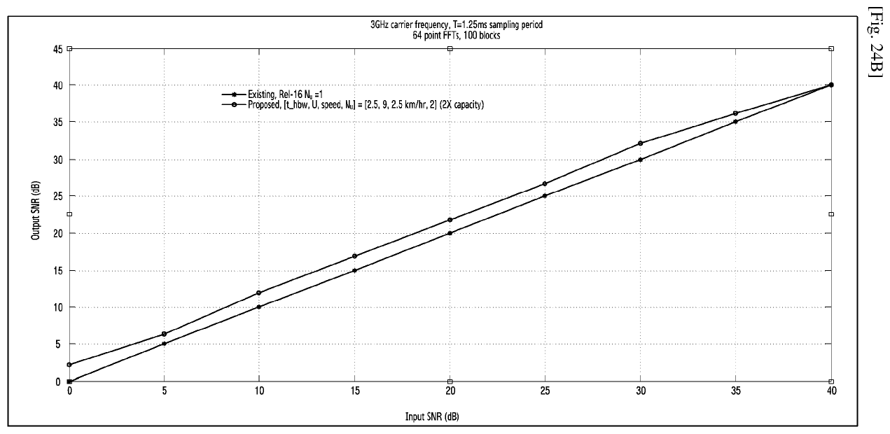

FIG. 23 is a graphical view illustrating curve fitting to solve Gibbs anomaly, according to the embodiments as disclosed herein.

Referring to FIG. 23, the graphical view depicts that the channel varies linearly or in a parabolic fashion, which results in Gibbs anomaly. In order to overcome the variation of channel, the proposed method applies curve fitting to solve the Gibbs anomaly.

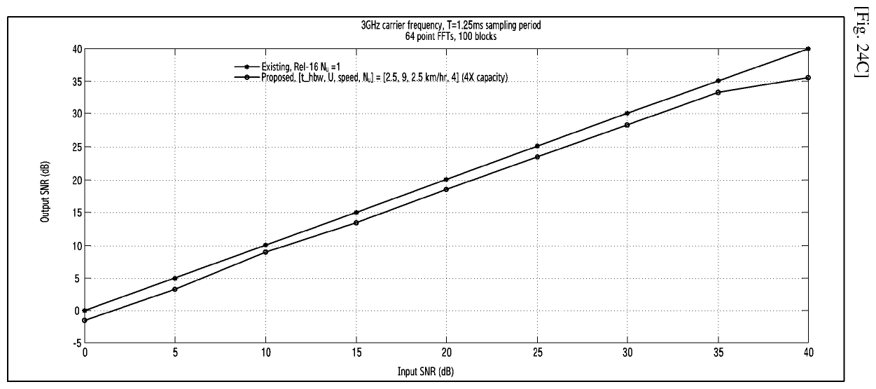

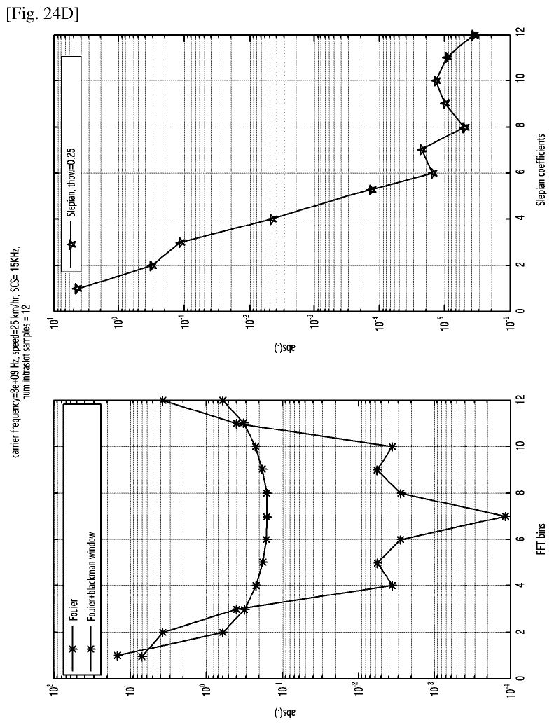

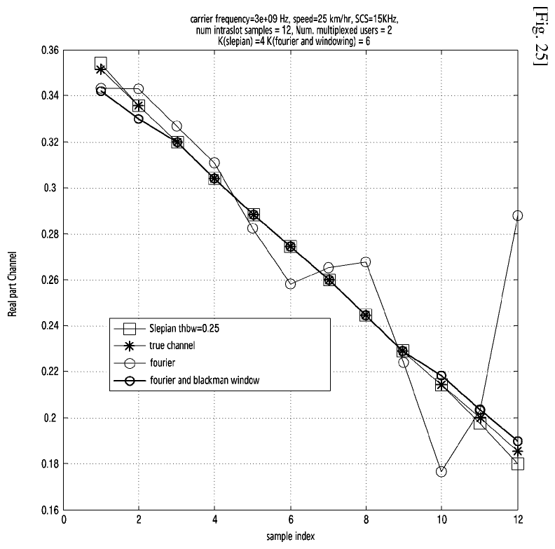

FIG. 24 and FIGS. 24A-24D are the graphical views illustrating Slepain theory and the simulation results of Slepain theory to solve the Gibbs problem, according to the embodiments as disclosed herein.

FIGS. 24A-24D illustrate various simulation results and a method to solve the Gibbs phenomenon using discrete prolate spheroidal (Slepian), and simulation results of proposed methods, according to an embodiment as disclosed herein.

DPSS or Slepian sequences are specially designed to deal with Spectral leakage or Gibbs phenomenon that a Fourier basis (FFT/IFFT) fails to overcome. For Fourier basis, 64-point FFT and U=32 FFT bins for IFFT are used and channel reconstruction is performed. In time-varying channel, DPSS or Slepian-based channel estimation for multi-users (many users using the same time-frequency resource) is better than Fourier-based channel estimation. Hence, the proposed method uses DPSS or Slepian-based channel estimation when two or more users (N_{U}) transmit SRS across one subcarrier over many OFDM symbols/slots (SRS occasions in time).

The relationship between a discrete signal x∈l₂(z) and its discrete time Fourier transform

$$( DTFT ) \tilde{x} ∈ {l}_{2} ( [ - \frac{1}{2} , \frac{1}{2} ] )$$

is given by

$$\tilde{x} ( f ) = {\sum }_{n = - ∞}^{∞} x [ n ] {e}^{- j 2 π fn} \qquad ( 19 )$$

$$x [ n ] = {\int }_{- \frac{1}{2}}^{\frac{1}{2}} x ( f ) {e}^{- j 2 π fn} df \qquad ( 20 )$$

For a given positive integer N and band limit

$$0 < W < \frac{1}{2} ,$$

the only signal which is bandlimited to f∈[−W,W], and time limited to n∈{0, 1, 2, . . . N−1} is the zero signal.

The proposed method finds time limited signals whose energy is maximally concentrated in the frequency interval [−W,W].

For any length N signal, x∈C^{N},

$$\frac{{\int }_{- W}^{W} {\vert \tilde{x} ( f ) \vert}^{2} df}{{\int }_{- 1 / 2}^{1 / 2} {\vert \tilde{x} ( f ) \vert}^{2} df} = \frac{x * {B}_{N , W} x}{x * x}$$

where, B_{N,W} is an N×N matrix with entries

$${B}_{N , W} [ m , n ] = \{ \begin{matrix}\frac{sin ( 2 π W ( m - n ) )}{π ( n - 1 )} & if m \neq n \\ 2 W & if m = n\end{matrix}$$

The Slepian basis vectors

$${S}_{N , W}^{( 0 )} , {S}_{N , W}^{( 1 )} , … …… ¨ {S}_{N , W}^{( N - 1 )} ,$$

are defined as the eigen vectors of B_{N,W}, where the respective eigen values

$${λ}_{N , W}^{( 0 )} , {λ}_{N , W}^{( 1 )} , … ¨ {λ}_{N , W}^{( N - 1 )}$$

are sorted in decreasing order.

Transmitter and receiver for N_{U}=2: User 1 transmits a=[1, 1, . . . , 1]T (first row/column of FFT matrix) across 64 SRS occasions in time domain on a given subcarrier. User 2 transmits b=[1, −1, 1, −1, . . . , −1]T (33rd row/column of FFT matrix) across 64 SRS occasions in time domain on a given subcarrier. hᵢ is the 64×1 vector of channels of the ith user. Noiseless case (for simplicity) what is received is y=a*h+b*h₂. “.*” means element-wise multiplication same as Matlab notation. The N×U matrix of DPSS (Slepian) sequence be D_{S}. This is DPSS (Slepian) orthonormal basis onto which the channel hᵢ is projected. All columns are orthogonal. Define A=[diag(a)*D_{S} diag(b).*D_{S}]. Diag(x), same as Matlab function, a diagonal matrix with vector x along diagonal. Compute the 2U×1 vector ρ=inv(A^{H}A)A^{H}y. This is the vector of DPSS coefficients modeling the channels of both users. Estimates of both channels across 64 SRS occasions in the time domain is given by ĥ₁=D_{S}ρ(1:U) and ĥ₂=Dρ(U+1:2U).

FIG. 24A illustrates the simulation result of how Slepain (DPSS) solves the Gibbs problem.

FIG. 24B illustrates that the proposed DPSS (Slepian) achieves 2× capacity at 25 km/hr almost same performance as existing standard. Subcarrier spacing is about 30 kHz, sampling once in 5 slots=1.25 msec, speed=25 km/hr. This is the same as sampling once every slot at 0.5 msec and speed=125 km/hr. So for higher speeds, more often sampling is recommended.

FIG. 24C illustrates that the proposed DPSS (Slepian) achieves 2× capacity at 2.5 km/hr better performance than existing standard. Subcarrier spacing is about 30 kHz, sampling once in 5 slots=1.25 msec, speed=2.5 km/hr. This is the same as sampling once every slot at 0.5 msec and speed=12.5 km/hr. So for higher speeds, more often sampling is recommended.

FIG. 24D illustrates that the proposed DPSS (Slepian) achieves 4× capacity at 2.5 km/hr almost same performance as existing standard. Subcarrier spacing is about 30 kHz, sampling once in 5 slots=1.25 msec, speed=2.5 km/hr. This is the same as sampling once every slot at 0.5 msec and speed=12.5 km/hr. So for higher speeds, more often sampling is recommended.

The graph illustrates the values of K, no. of bins is less for Slepian basis. K=4 only. Windowing reduces spectral leakage of Fourier basis, so more energy is concentrated in K/2 bins out of Nbins. Typically K=6. Fourier and window reduce Gibbs effect but Slepian is the one that reduces the Gibbs effect the most.

The SRS pattern for intra-slot patterns that are being considered for existing standard are used in this simulations. For capacity and SNR improvement, consider multiplexing two/four users with the same cyclic shift, same comb, and same time-frequency resources. The proposed SRS design/method consider the capacity and performance improvement with respect to the existing or the proposed standard. For proposed transmission and receiver enhancements, consider Fourier, Fourier and window, and Slepain (DPSS) receivers. Simulation parameters, performance curves of Slepian, Fourier, Fourier and window for various speeds and comparisons with respect to the existing or the proposed standard, and performance and Slepian method dependency on time half bandwidth parameter.

Proposed standard intra Slot SRS pattern:
Possible values of (N_symbol, R) are {(8, 1), (8, 2), (8, 4), (8, 8), (12, 1), (12, 2), (12, 3), (12, 4), (12, 6), (12, 12), (10, 1), (10, 2), (10, 5), (10,10), (14, 1), (14, 2), (14, 7), (14, 14)}

The definition of N_symbol, R, and their relation is the same as what is defined as in the current specification. R denotes the number of contiguous repetition symbols. SoN_sybmol=8 and R=1 means only one repetition with 8 times of frequency hopping. Likewise, N_sybmol=8 and R=2 mean two repetitions with 4 times of frequency hopping.

Transmission and receiver enhancements: Two or Four users transmit on the same N=R OFDM symbols within the slot on a designated subcarrier (same time-frequency resources). Different values are transmitted over N symbols, and denoted by a and b, respectively, and are of N×1 dimension vectors. hᵢ is the N×1 vector of channels of the i^{th} user. y=a.*h₁+b.*h₂. “.*” is received during noiseless case, which means element-wise multiplication same as Matlab notation. Let D be an N×K matrix (all columns being orthogonal) that can model the N×1 channel as hᵢ=Dcᵢ where cᵢ is a K×1 vector of coefficients.

Define A=[diag(a)*D diag(b).*D]. Diag(x), same as matlab function, a diagonal matrix with vector x along diagonal. a and b should be such that A is full rank and invertible. Compute the 2K×1 vector ρ=inv(A^{H}A)A^{H}y. This is the vector of coefficients modelling the channels of both users. To have A, of dimension N×2K, invertible N≥2K, i.e., the number of coefficients modeling the channels of all users (that needs to be estimated) should be less than the number of observations N. Estimates of both channels across is given by ĥ₁=Dρ(1:U) and ĥ₂=Dρ(U+1:2U).

Slepian (DPSS) Basis:

Dₛ is N×N matrix (N orthogonal columns) can be generated by Matlabdpss(N, tbhw, N) function. Generates N (third parameter) sequences of length N (first parameter). tbhw called as time_halfbandwidth.

Show performance benefits for speeds from 5 km/hr to 250 km/hr over a range of time_half bandwidth values, thereby showing no dependency of time_halfbandwidth on speed.

Use K=4 for multiplexing two users and K=3 for multiplexing four users for N=12 OFDM symbols in a slot. So D=Dₛ(:, 1:K).

Fourier and Fourier and window Basis:
N×NFFT matrix F_{N} is defined as

$$F ( i , j ) = {e}^{- \frac{j 2 π ij}{N}} , 0 \leq i , j \leq N - 1.$$

$$D = \frac{1}{N} {F}_{N}^{H} ( : , \frac{K}{2} N - \frac{K}{2} + 1 : N )$$

(First and last K/2 columns).

When a window (Blackman or Hann) is used, multiply y by the window vector as the first step and in the last step ĥᵢ is divided by the window vector to get the channel estimate.

Windowing reduces Spectral leakage so can improve performance compared to Fourier basis (when K out of N FFT bins are used, so more bin energy gets concentrated in the K bins).

Simulation parameters:

N=12. K=4 for two multiplexing users or K=3 for four multiplexing users. K=6 for Fourier and Fourier and window basis. Window (Blackman, Hann).

Here, consider a simplified simulator where only one subcarrier is simulated (No cyclic shifts or combs in frequency domain).

No frequency domain processing. Input SNR corresponds to one subcarrier in any one OFDM symbol only. So for baseline performance (Rel-16/17) input SNR=output SNR.

The proposed method does time-domain processing, so output SNR increases. Further multiplexing is done, so capacity improves but SNR could decrease.

3 GHz carrier frequency. 15 kHz subcarrier spacing. Speed=5 km/hr-250 km/hr.

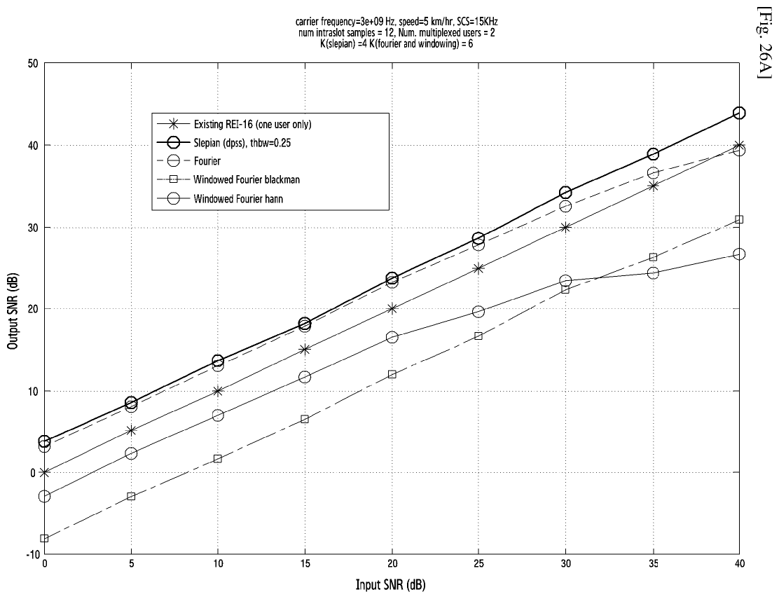

FIG. 25 is a graphical view illustrating the simulation result of the channel reconstruction, according to the embodiments as disclosed herein.

FIG. 25 illustrates the channel reconstruction in noiseless case. Slepian reconstructs the channel by Fourier and window and then Fourier, and notices that the error increases at the edges (Gibbs effect).

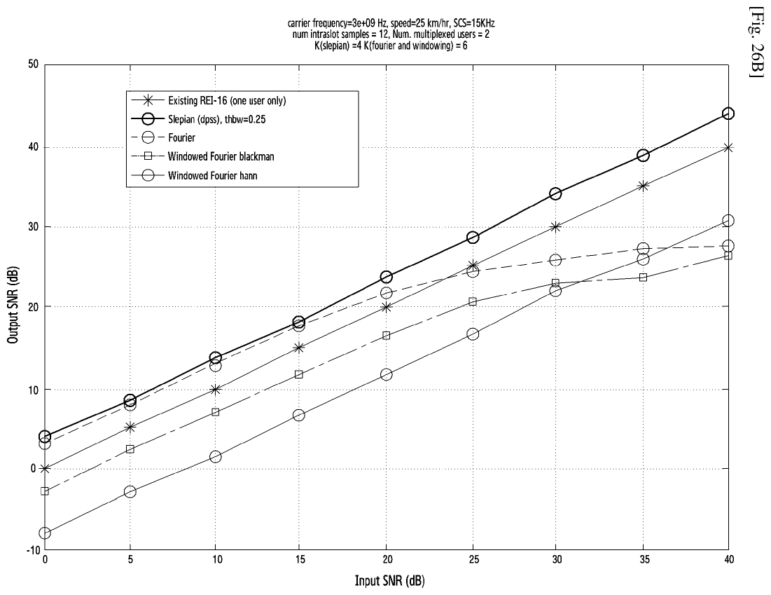

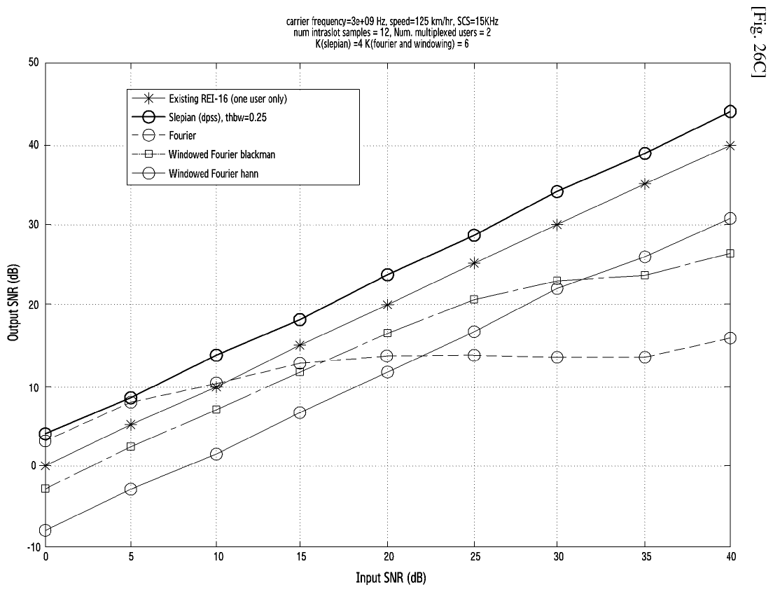

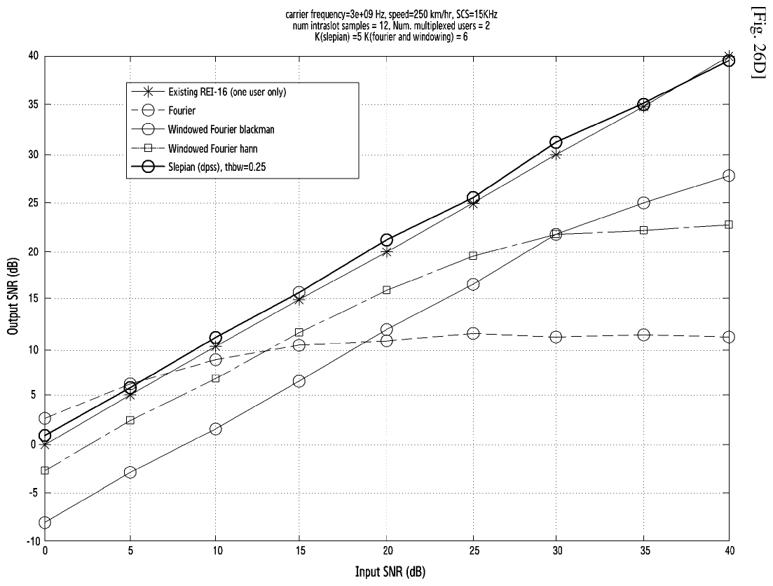

FIG. 26A-26D are graphical views illustrating the comparison of the existing methods and the proposed method for increasing capacity of SRS, according to the embodiments as disclosed herein.

FIG. 26A-26D illustrates a comparison of methods, for different parameters (e.g. Speeds of 5 km/hr-250 km/hr at 15 kHz subcarrier spacing and 3 GHZ carrier frequency), 200% capacity increase of proposed method compared to existing standard, and performance improvement also with respect to existing standard, and performance comparisons with Fourier and windowed-Fourier methods are performed.

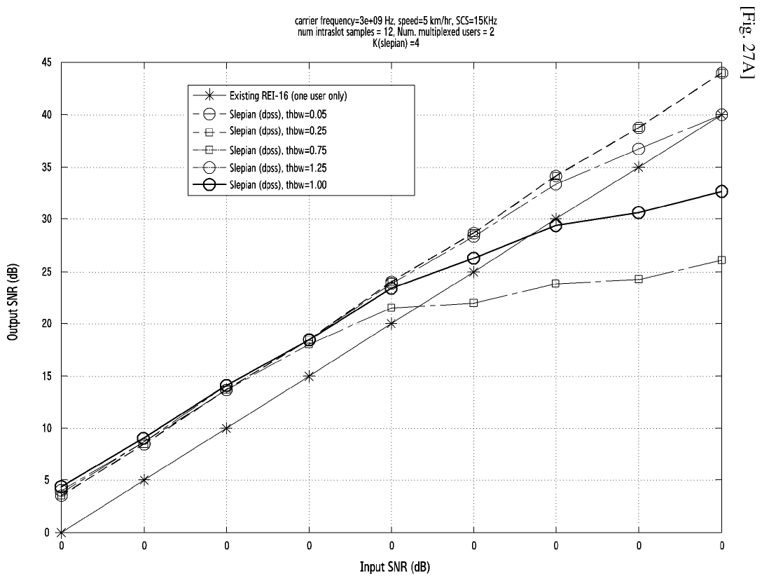

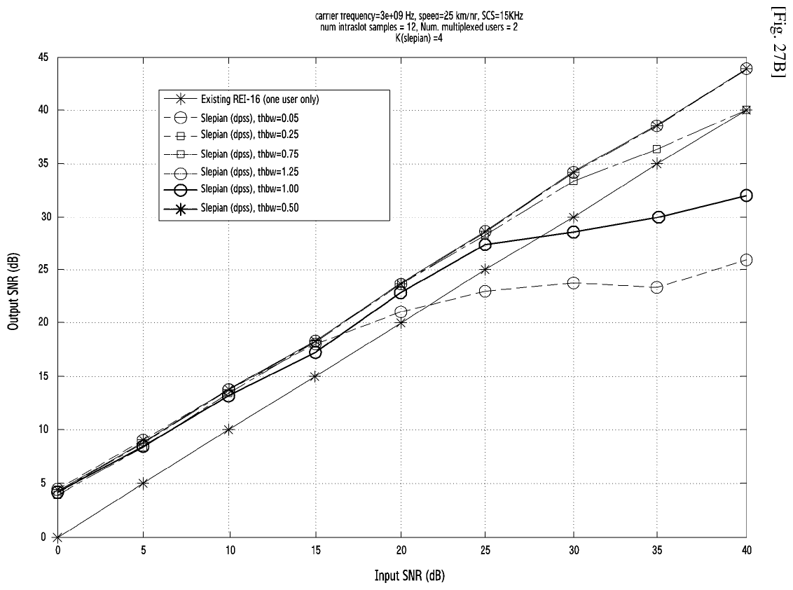

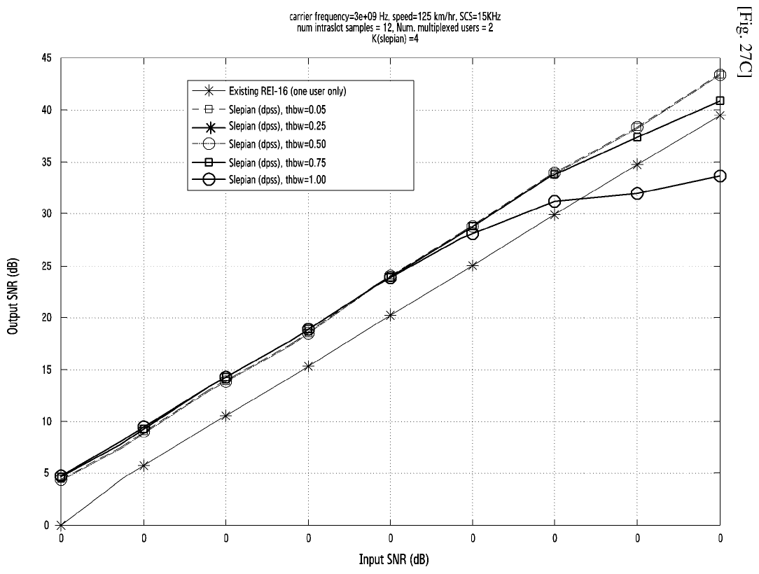

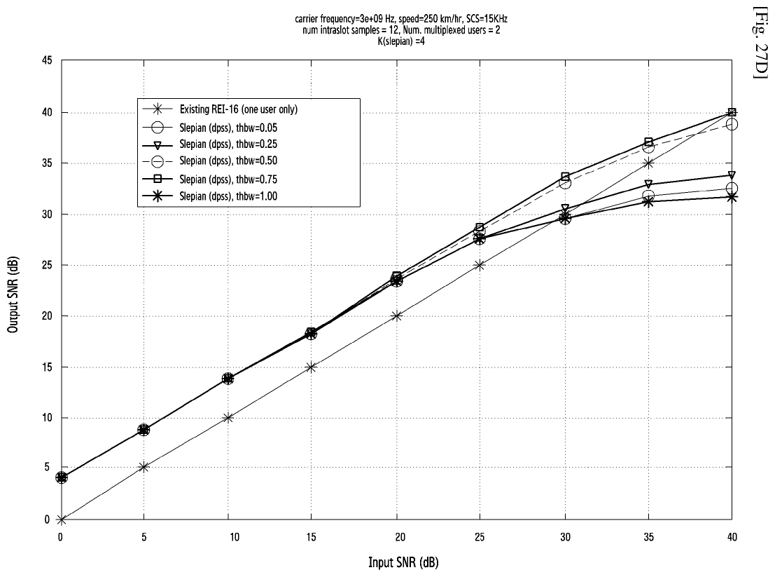

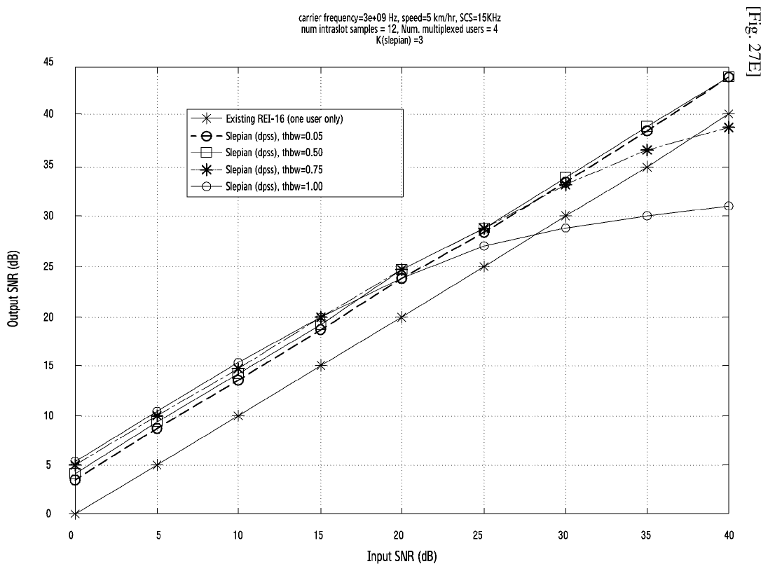

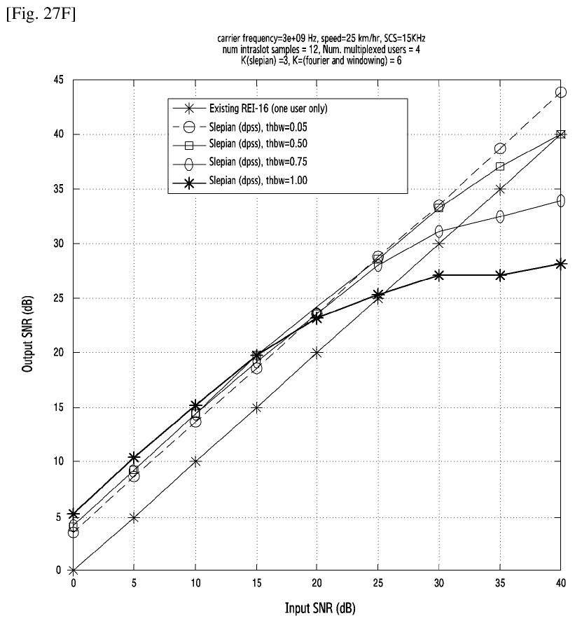

FIG. 27A-27G are graphical views illustrating the simulation results for dependence of Slepian on time-half bandwidth for increasing capacity of SRS, according to the embodiments as disclosed herein.

FIGS. 27A-27D illustrate the comparison of methods, for different parameters (e.g. Speeds of 5 km/hr-250 km/hr at 15 kHz subcarrier spacing and 3 GHZ carrier frequency), resulting in 200% capacity increase of proposed method compared to the existing method, and performance improvement also with respect to the existing standard, and performance comparisons with Fourier and windowed-Fourier methods are performed in dependence of Slepian on time_halfbandwidth for 2× capacity increase.

FIGS. 27E-27G illustrate the comparison of methods, for different parameters (e.g. Speeds of 5 km/hr-250 km/hr at 15 kHz subcarrier spacing and 3 GHZ carrier frequency), resulting in 400% capacity increase of proposed method compared to the existing method, and performance improvement also with respect to the existing standard, and performance comparisons with Fourier and windowed-Fourier methods are performed in dependence of Slepian on time_halfbandwidth for 4× capacity increase.

CDM or TD-OCC is applied over a set of OFDM symbols and if over these set of OFDM symbols, the channel is roughly constant, it corresponds to a non-Doppler case and if channel is changing appreciably over these OFDM symbols it is a Doppler case. Description regarding FIG. 5 through FIG. 8 generally refers to the non-Doppler case while description of Proposed standard intra Slot SRS pattern, Transmission and receiver enhancements, Slepian (DPSS) Basis, Fourier and Fourier and window Basis, Simulation parameters, description regarding FIG. 25 through FIG. 27G generally represents a Doppler case. For the non-Doppler case we have shown it in the context of both CDM and CS/ZC codes while for simplicity, the Doppler case is shown in the context of CDM only. Those skilled in the art, can extend the non-Doppler case to the Doppler case and apply both CDM and CS/ZC multiplexing to the Doppler case similarly.

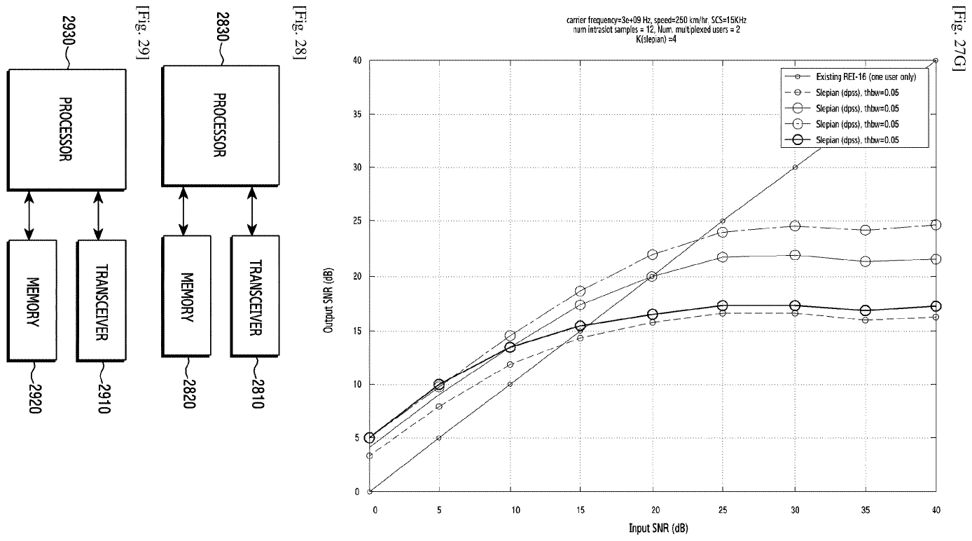

FIG. 28 is a block diagram of an internal configuration of a base station, according to an embodiment of the disclosure.

Referring to FIG. 28, the base station according to an embodiment may include a transceiver 2810, a memory 2820, and a processor 2830. The transceiver 2810, the memory 2820, and the processor 2830 of the base station may operate according to a communication method of the base station described above. However, the components of the base station are not limited thereto. For example, the base station may include more or fewer components than those described above. In addition, the processor 2830, the transceiver 2810, and the memory 2820 may be implemented as a single chip. Also, the processor 2830 may include at least one processor.

The transceiver 2810 collectively refers to a base station receiver and a base station transmitter, and may transmit/receive a signal to/from a terminal. The signal transmitted or received to or from the terminal may include control information and data. The transceiver 2810 may include a RF transmitter for up-converting and amplifying a frequency of a transmitted signal, and a RF receiver for amplifying low-noise and down-converting a frequency of a received signal. However, this is only an example of the transceiver 2810 and components of the transceiver 2810 are not limited to the RF transmitter and the RF receiver.

Also, the transceiver 2810 may receive and output, to the processor 2830, a signal through a wireless channel, and transmit a signal output from the processor 2830 through the wireless channel.

The memory 2820 may store a program and data required for operations of the base station. Also, the memory 2820 may store control information or data included in a signal obtained by the base station. The memory 2820 may be a storage medium, such as read-only memory (ROM), random access memory (RAM), a hard disk, a CD-ROM, and a DVD, or a combination of storage media.

The processor 2830 may control a series of processes such that the base station operates as described above. For example, the transceiver 2810 may receive a data signal including a control signal transmitted by the terminal, and the processor 2830 may determine a result of receiving the control signal and the data signal transmitted by the terminal.

FIG. 29 is a block diagram showing an internal structure of a terminal, according to an embodiment of the disclosure.

Referring to FIG. 29, the terminal of the disclosure may include a transceiver 2910, a memory 2920, and a processor 2930. The transceiver 2910, the memory 2920, and the processor 2930 of the terminal may operate according to a communication method of the terminal described above. However, the components of the terminal are not limited thereto. For example, the terminal may include more or fewer components than those described above. In addition, the processor 2930, the transceiver 2910, and the memory 2920 may be implemented as a single chip. Also, the processor 2930 may include at least one processor.

The transceiver 2910 collectively refers to a terminal receiver and a terminal transmitter, and may transmit/receive a signal to/from a base station. The signal transmitted or received to or from the base station may include control information and data. In this regard, the transceiver 2910 may include a RF transmitter for up-converting and amplifying a frequency of a transmitted signal, and a RF receiver for amplifying low-noise and down-converting a frequency of a received signal. However, this is only an example of the transceiver 2910 and components of the transceiver 2910 are not limited to the RF transmitter and the RF receiver.

Also, the transceiver 2910 may receive and output, to the processor 2930, a signal through a wireless channel, and transmit a signal output from the processor 2930 through the wireless channel.

The memory 2920 may store a program and data required for operations of the terminal. Also, the memory 2920 may store control information or data included in a signal obtained by the terminal. The memory 2920 may be a storage medium, such as ROM, RAM, a hard disk, a CD-ROM, and a DVD, or a combination of storage media.

The processor 2930 may control a series of processes such that the terminal operates as described above. For example, the transceiver 2910 may receive a data signal including a control signal, and the processor 2930 may determine a result of receiving the data signal.

The embodiments of the present disclosure provides a method for managing sounding reference signal (SRS) transmission in a wireless communication, the method comprises: receiving, by a base station (100) in the wireless communication, the SRS transmitted from a group of user equipments (UEs) (200a-200d) in the wireless communication over same time-frequency resource, wherein the SRS is transmitted using a transmission variant; wherein the transmission variant is configured by at least one of a time-frequency resource allocation, a cyclic shift/Zadoff-Chu (ZC) code along the subcarriers in at least one OFDM symbol, a code division multiplexing (CDM) code along the OFDM symbols in at least one subcarrier and a comb offset information across the OFDM symbols; determining, by the base station (100), the transmission variant for decoding the SRS, wherein the transmission variant is at least one of a constant CDM across the SRS subcarriers and constant cyclic shift (CS)/ZC code across the OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across OFDM symbols (C-CDM-V-CS) variant; where in the CDM for the subcarrier is across a plurality of OFDM symbols, CS/ZC code for the OFDM symbol is across the subcarriers; where in the SRS subcarriers in any OFDM symbol are mapped to an appropriate comb; and performing, by the base station (100), one of: estimating at least one channel between the UEs (200a-200d) and the base station (100) corresponding to the SRS from each UE of the group of UEs (200a-200d) in the slot using a first receiver when the transmission variant is one of the C-CDM-C-CS variant or the V-CDM-C-CS variant, and estimating at least one channel between the UEs (200a-200d) and the base station (100) corresponding to the SRS from each UE of the group of UEs (200a-200d) in the slot using a second receiver when the transmission variant is one of the C-CDM-C-CS variant or the C-CDM-V-CS variant.

In an embodiment, the receiving, by the base station (100), of the SRS transmitted from the group of UEs (200a-200d) over the same time-frequency resource may include: transmitting, by the base station (100), a radio resource control (RRC) message to each of the UE in the group of UEs (200a-200d) for transmission of SRS across the subcarriers and the OFDM symbols in designated slots where the SRS is transmitted by the group of UEs (200a-200d), wherein the RRC message comprises at least one of the time-frequency resource allocation, the CDM code allocation, a CS code allocation, the ZC code allocation, and the comb offset information; and receiving, by the base station (100), the SRS transmitted from the group of UEs (200a-200d) over the same time-frequency resource across the subcarriers and the OFDM symbols in the designated slots, wherein the SRS is transmitted based on the RRC message.

In an embodiment, the method may include: receiving, by each UE of the group of UEs (200a-200d), the RRC message from the base station (100); creating, by each UE of the group of UEs (200a-200d), SRS vector in each OFDM symbol based on the at least one code applied to the OFDM symbols in the designated slots; mapping, by each UE of the group of UEs (200a-200d), the SRS vector to the appropriate comb in the OFDM symbol based on the comb offset information applied to the OFDM symbols in the designated slots; coding, by each UE of the group of UEs (200a-200d), the SRS based on the at least one code and the comb offset information applied to the OFDM symbols in the designated slots; and sending, by each UE of the group of UEs (200a-200d), the SRS in the wireless communication to the base station (100).

In an embodiment, the determining, by the base station (100), of the transmission variant for decoding the SRS may include: applying, by the base station (100), at least one multiplexing to the OFDM symbols in the designated slots provided by the base station; separating, by the base station (100), the SRS transmitted by the group of UEs (200a-200d) over same time-frequency resource based on the at least one multiplexing applied to the OFDM symbols in the designated slots provided by the base station (100); and determining, by the base station (100), at least one transmission variant from the C-CDM-C-CS variant, V-CDM-C-CS variant, or C-CDM-V-CS variant during transmission of the SRS by the group of UEs (200a-200d).

In an embodiment, the applying, by the base station (100), of the at least one multiplexing to the OFDM symbols in the designated slot may include one of: applying, by the base station (100), time-domain orthogonal cover code (TD-OCC) across the OFDM symbols in the designated slot; applying, by the base station (100), a combination of TD-OCC and frequency hopping to the OFDM symbols in the designated slot for determining interference of the at least two SRS; applying, by the base station (100), a combination of TD-OCC, frequency hopping and comb hopping to the OFDM symbols in the designated slot; and applying by the base station (100), a combination of TD-OCC/CDM, CS/ZC code hopping and comb hopping to the OFDM symbols in the designated slot.

In an embodiment, separating, by the base station (100), of the SRS transmitted by the group of UEs (200a-200d) over same time-frequency resource based on the at least one multiplexing applied to the OFDM symbols in the designated slot for estimating the channels of the group of UEs (200a-200d) to the base station (100) may include at least one of: separating, by the base station (100), the SRS transmitted by the group of UEs in CDM domain first and in then CS domain for the C-CDM-C-CS variant and V-CDM-C-CS variant; and separating, by the base station (100), the SRS transmitted by the group of UEs in CS domain first and in then CDM domain for the C-CDM-C-CS variant and the C-CDM-V-CS variant.

In an embodiment, the at least one channel from the UEs (200a-200d) to the base station (100) corresponding to the SRS from each UE of the group of UEs (200a-200d) in the slot using the first receiver may include: determining, by the base station (100), a received time domain vector for each SRS subcarrier based on the comb offset information applied across the OFDM symbols in the designated slots; determining, by the base station (100), a CDM vector for at least one CDM group in each SRS subcarrier along the OFDM symbols in the designated slots; determining, by the base station (100), an effective channel vector for at least one CDM group in each SRS subcarrier based on the determined time domain vector and the determined CDM vector; determining, by the base station (100), various CS group vectors; determining, by the base station (100), the effective channel vector for at least one CDM group across the SRS subcarriers; and estimating, by the base station (100), at least one channel from the UEs (200a-200d) to the base station (100) corresponding to the SRS from each UE of the group of UEs (200a-200d).

In an embodiment, the estimating of at least one channel from the UEs (200a-200d) to the base station (100) corresponding to the SRS from each UE of the group of Ues in the slot using the second receiver may included: determining, by the base station (100), a received signal vector across each SRS subcarrier in the appropriate comb of the at least one OFDM symbol; determining, by the base station (100), the CS vectors along each SRS subcarrier in the appropriate comb of the at least one OFDM symbol; determining, by the base station (100), the effective channel vector for all the CS groups at an OFDM symbol, repeating across OFDM symbols; determining, by the base station (100), the effective channel vector of at least one CS group across the OFDM symbols; determining, by the base station (100), at least one CDM group vector across the OFDM symbols; and estimating, by the base station (100), at least one channel from the Ues (200a-200d) to the base station (100) corresponding to the SRS from each UE of the group of Ues (200a-200d).

In an embodiment, the group of UEs (200a-200d) has same ZC code across the OFDM symbols for the SRS when the transmission variant is the C-CDM-C-CS variant or V-CDM-C-CS variant.

In an embodiment, the group of UEs (200a-200d) has same ZC code in at least one OFDM symbol but varies across the plurality of OFDM symbols for the SRS when the transmission variant is the C-CDM-V-CS variant.

In an embodiment, XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with a CDM unique to that subgroup that is same across all the SRS subcarriers; wherein each UE of the subgroup is assigned with one of the Y CS/ZC codes that is same across all OFDM symbols such that the UEs in the subgroup have an unique CS/ZC from the Y ZC/CS codes; wherein the code assignment corresponds to the C-CDM-C-CS variant.

In an embodiment, the XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with the CDM unique to that subgroup across the given SRS subcarrier; wherein each UE of a subgroup is assigned with one of the Y CS/ZC codes across the plurality of OFDM symbols such that the UEs in a subgroup have an unique CS/ZC from the Y ZC/CS codes; wherein the code assignment corresponds to the V-CDM-C-CS variant.

In an embodiment, the XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with the CDM unique to that subgroup that is constant across all SRS subcarriers; wherein each UE of the subgroup is assigned with one of the Y CS/ZC codes for the given OFDM symbol such that the UEs in the subgroup have an unique CS/ZC from the Y ZC/CS codes for that given OFDM symbol; wherein the code assignment corresponds to the C-CDM-V-CS variant.

The embodiments of the present disclosure provide a base station (100) for managing sounding reference signal (SRS) transmission in a wireless communication, the method comprises: a memory (110); a processor (120) coupled to the memory (110); and a communicator (130) coupled to the memory (110) and the processor (120), the processor (120) is configured to: receive the SRS transmitted from a group of user equipments (UEs) (200a-200d) in the wireless communication over same time-frequency resource, wherein the SRS is transmitted using a transmission variant; wherein the transmission variant is configured by at least one of a time-frequency resource allocation, a cyclic shift/Zadoff-Chu (ZC) code along the subcarriers in at least one OFDM symbol, a code division multiplexing (CDM) code along the OFDM symbols in at least one subcarrier and a comb offset information across the OFDM symbols; determine the transmission variant for decoding the SRS, wherein the transmission variant is at least one of a constant CDM across the SRS subcarriers and constant cyclic shift (CS)/ZC code across the OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across OFDM symbols (C-CDM-V-CS) variant; wherein the CDM for the subcarrier is across a plurality of OFDM symbols, CS/ZC code for the OFDM symbol is across the subcarriers; wherein the SRS subcarriers in any OFDM symbol are mapped to an appropriate comb; and performing, by the base station (100), one of: estimating at least one channel between the UEs (200a-200d) and the base station (100) corresponding to the SRS from each UE of the group of UEs (200a-200d) in the slot using a first receiver when the transmission variant is one of the C-CDM-C-CS variant or the V-CDM-C-CS variant, and estimating at least one channel between the UEs (200a-200d) and the base station (100) corresponding to the SRS from each UE of the group of UEs (200a-200d) in the slot using a second receiver when the transmission variant is one of the C-CDM-C-CS variant or the C-CDM-V-CS variant.

In an embodiment, the processor is configured to: transmit a radio resource control (RRC) message to each of the UE in the group of UEs (200a-200d) for transmission of SRS across the subcarriers and the OFDM symbols in designated slots where the SRS is transmitted by the group of UEs (200a-200d), wherein the RRC message comprises at least one of the time-frequency resource allocation, the CDM code allocation, a CS code allocation, the ZC code allocation, and the comb offset information; and receive the SRS transmitted from the group of UEs (200a-200d) over the same time-frequency resource across the subcarriers and the OFDM symbols in the designated slots, wherein the SRS is transmitted based on the RRC message.

In an embodiment, each UE of the group of UEs (200a-200d): receives the RRC message from the base station (100); creates SRS vector in each OFDM symbol based on the at least one code applied to the OFDM symbols in the designated slots; map the SRS vector to the appropriate comb in the OFDM symbol based on the comb offset information applied to the OFDM symbols in the designated slots; code the SRS based on the at least one code and the comb offset information applied to the OFDM symbols in the designated slots; and send the SRS in the wireless communication to the base station (100).

In an embodiment, the processor is configured to: apply at least one multiplexing to the OFDM symbols in the designated slots provided by the base station; separate the SRS transmitted by the group of UEs (200a-200d) over same time-frequency resource based on the at least one multiplexing applied to the OFDM symbols in the designated slots provided by the base station (100); and determine at least one transmission variant from the C-CDM-C-CS variant, V-CDM-C-CS variant, or C-CDM-V-CS variant during transmission of the SRS by the group of UEs (200a-200d).

In an embodiment, the processor is configured to perform at least one of: apply time-domain orthogonal cover code (TD-OCC) across the OFDM symbols in the designated slot; apply a combination of TD-OCC and frequency hopping to the OFDM symbols in the designated slot for determining interference of the at least two SRS; apply a combination of TD-OCC, frequency hopping and comb hopping to the OFDM symbols in the designated slot; and apply a combination of TD-OCC/CDM, CS/ZC code hopping and comb hopping to the OFDM symbols in the designated slot.

In an embodiment, the processor is configured to perform at least one of: separating, by the base station (100), the SRS transmitted by the group of UEs in CDM domain first and in then CS domain for the C-CDM-C-CS variant and V-CDM-C-CS variant; and separating, by the base station (100), the SRS transmitted by the group of UEs in CS domain first and in then CDM domain for the C-CDM-C-CS variant and the C-CDM-V-CS variant.

In an embodiment, the processor is configured to: determine a received time domain vector for each SRS subcarrier based on the comb offset information applied across the OFDM symbols in the designated slots; determine a CDM vector for at least one CDM group in each SRS subcarrier along the OFDM symbols in the designated slots; determine an effective channel vector for at least one CDM group in each SRS subcarrier based on the determined time domain vector and the determined CDM vector; determine various CS group vectors; determine the effective channel vector for at least one CDM group across the SRS subcarriers; and estimate at least one channel from the UEs (200a-200d) to the base station (100) corresponding to the SRS from each UE of the group of UEs (200a-200d).

In an embodiment, the processor is configured to: determine a received signal vector across each SRS subcarrier in the appropriate comb of the at least one OFDM symbol; determine the CS vectors along each SRS subcarrier in the appropriate comb of the at least one OFDM symbol; determine the effective channel vector for all the CS groups at an OFDM symbol, repeating across OFDM symbols; determine the effective channel vector of at least one CS group across the OFDM symbols; determine at least one CDM group vector across the OFDM symbols; and estimate at least one channel from the UEs (200a-200d) to the base station (100) corresponding to the SRS from each UE of the group of UEs (200a-200d).

In an embodiment, the group of UEs (200a-200d) has same ZC code across the OFDM symbols for the SRS when the transmission variant is the C-CDM-C-CS variant or V-CDM-C-CS variant.

In an embodiment, the group of UEs (200a-200d) has same ZC code in at least one OFDM symbol but varies across the plurality of OFDM symbols for the SRS when the transmission variant is the C-CDM-V-CS variant.

In an embodiment, XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with a CDM unique to that subgroup that is same across all the SRS subcarriers; wherein each UE of the subgroup is assigned with one of the Y CS/ZC codes that is same across all OFDM symbols such that the UEs in the subgroup have an unique CS/ZC from the Y ZC/CS codes; wherein the code assignment corresponds to the C-CDM-C-CS variant.

In an embodiment, the XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with the CDM unique to that subgroup across the given SRS subcarrier; wherein each UE of a subgroup is assigned with one of the Y CS/ZC codes across the plurality of OFDM symbols such that the UEs in a subgroup have an unique CS/ZC from the Y ZC/CS codes; wherein the code assignment corresponds to the V-CDM-C-CS variant.

In an embodiment, the XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with the CDM unique to that subgroup that is constant across all SRS subcarriers; wherein each UE of the subgroup is assigned with one of the Y CS/ZC codes for the given OFDM symbol such that the UEs in the subgroup have an unique CS/ZC from the Y ZC/CS codes for that given OFDM symbol; wherein the code assignment corresponds to the C-CDM-V-CS variant.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for managing sounding reference signal (SRS) transmission in a wireless communication, wherein the method comprises:
receiving, by a base station (100) in the wireless communication, the SRS transmitted from a group of user equipments (UEs) (200a-200d) in the wireless communication over same time-frequency resource, wherein the SRS is transmitted using a transmission variant; wherein the transmission variant is configured by at least one of a time-frequency resource allocation, a cyclic shift/Zadoff-Chu (ZC) code along the subcarriers in at least one OFDM symbol, a code division multiplexing (CDM) code along the OFDM symbols in at least one subcarrier and a comb offset information across the OFDM symbols;
determining, by the base station (100), the transmission variant for decoding the SRS, wherein the transmission variant is at least one of a constant CDM across the SRS subcarriers and constant cyclic shift (CS)/ZC code across the OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across OFDM symbols (C-CDM-V-CS) variant; where in the CDM for the subcarrier is across a plurality of OFDM symbols, CS/ZC code for the OFDM symbol is across the subcarriers; where in the SRS subcarriers in any OFDM symbol are mapped to an appropriate comb; and
performing, by the base station (100), one of:
estimating at least one channel between the UEs (200a-200d) and the base station (100) corresponding to the SRS from each UE of the group of UEs (200a-200d) in the slot using a first receiver when the transmission variant is one of the C-CDM-C-CS variant or the V-CDM-C-CS variant, and
estimating at least one channel between the UEs (200a-200d) and the base station (100) corresponding to the SRS from each UE of the group of UEs (200a-200d) in the slot using a second receiver when the transmission variant is one of the C-CDM-C-CS variant or the C-CDM-V-CS variant.

2. The method as claimed in claim 1, wherein receiving, by the base station (100), the SRS transmitted from the group of UEs (200a-200d) over the same time-frequency resource comprises:
transmitting, by the base station (100), a radio resource control (RRC) message to each of the UE in the group of UEs (200a-200d) for transmission of SRS across the subcarriers and the OFDM symbols in designated slots where the SRS is transmitted by the group of UEs (200a-200d), wherein the RRC message comprises at least one of the time-frequency resource allocation, the CDM code allocation, a CS code allocation, the ZC code allocation, and the comb offset information; and
receiving, by the base station (100), the SRS transmitted from the group of UEs (200a-200d) over the same time-frequency resource across the subcarriers and the OFDM symbols in the designated slots, wherein the SRS is transmitted based on the RRC message.

3. The method as claimed in claim 2, wherein the method comprises:
receiving, by each UE of the group of UEs (200a-200d), the RRC message from the base station (100);
creating, by each UE of the group of UEs (200a-200d), SRS vector in each OFDM symbol based on the at least one code applied to the OFDM symbols in the designated slots;
mapping, by each UE of the group of UEs (200a-200d), the SRS vector to the appropriate comb in the OFDM symbol based on the comb offset information applied to the OFDM symbols in the designated slots;
coding, by each UE of the group of UEs (200a-200d), the SRS based on the at least one code and the comb offset information applied to the OFDM symbols in the designated slots; and
sending, by each UE of the group of UEs (200a-200d), the SRS in the wireless communication to the base station (100).

4. The method as claimed in claim 1, wherein determining, by the base station (100), the transmission variant for decoding the SRS comprises:
applying, by the base station (100), at least one multiplexing to the OFDM symbols in the designated slots provided by the base station;
separating, by the base station (100), the SRS transmitted by the group of UEs (200a-200d) over same time-frequency resource based on the at least one multiplexing applied to the OFDM symbols in the designated slots provided by the base station (100); and
determining, by the base station (100), at least one transmission variant from the C-CDM-C-CS variant, V-CDM-C-CS variant, or C-CDM-V-CS variant during transmission of the SRS by the group of UEs (200a-200d).

5. The method as claimed in claim 4, wherein applying, by the base station (100), at least one multiplexing to the OFDM symbols in the designated slot comprises one of:
applying, by the base station (100), time-domain orthogonal cover code (TD-OCC) across the OFDM symbols in the designated slot;
applying, by the base station (100), a combination of TD-OCC and frequency hopping to the OFDM symbols in the designated slot for determining interference of the at least two SRS;
applying, by the base station (100), a combination of TD-OCC, frequency hopping and comb hopping to the OFDM symbols in the designated slot; and
applying by the base station (100), a combination of TD-OCC/CDM, CS/ZC code hopping and comb hopping to the OFDM symbols in the designated slot.

6. The method as claimed in claim 4, wherein separating, by the base station (100), the SRS transmitted by the group of UEs (200a-200d) over same time-frequency resource based on the at least one multiplexing applied to the OFDM symbols in the designated slot for estimating the channels of the group of UEs (200a-200d) to the base station (100) comprises at least one of:
separating, by the base station (100), the SRS transmitted by the group of UEs in CDM domain first and in then CS domain for the C-CDM-C-CS variant and V-CDM-C-CS variant; and
separating, by the base station (100), the SRS transmitted by the group of UEs in CS domain first and in then CDM domain for the C-CDM-C-CS variant and the C-CDM-V-CS variant.

7. The method as claimed in claim 1, wherein estimating at least one channel from the UEs (200a-200d) to the base station (100) corresponding to the SRS from each UE of the group of UEs (200a-200d) in the slot using the first receiver comprises:
determining, by the base station (100), a received time domain vector for each SRS subcarrier based on the comb offset information applied across the OFDM symbols in the designated slots;
determining, by the base station (100), a CDM vector for at least one CDM group in each SRS subcarrier along the OFDM symbols in the designated slots;
determining, by the base station (100), an effective channel vector for at least one CDM group in each SRS subcarrier based on the determined time domain vector and the determined CDM vector;
determining, by the base station (100), various CS group vectors;
determining, by the base station (100), the effective channel vector for at least one CDM group across the SRS subcarriers; and
estimating, by the base station (100), at least one channel from the UEs (200a-200d) to the base station (100) corresponding to the SRS from each UE of the group of UEs (200a-200d).

8. The method as claimed in claim 1, wherein estimating at least one channel from the UEs (200a-200d) to the base station (100) corresponding to the SRS from each UE of the group of Ues in the slot using the second receiver comprises:
determining, by the base station (100), a received signal vector across each SRS subcarrier in the appropriate comb of the at least one OFDM symbol;
determining, by the base station (100), the CS vectors along each SRS subcarrier in the appropriate comb of the at least one OFDM symbol;
determining, by the base station (100), the effective channel vector for all the CS groups at an OFDM symbol, repeating across OFDM symbols;
determining, by the base station (100), the effective channel vector of at least one CS group across the OFDM symbols;
determining, by the base station (100), at least one CDM group vector across the OFDM symbols; and
estimating, by the base station (100), at least one channel from the Ues (200a-200d) to the base station (100) corresponding to the SRS from each UE of the group of Ues (200a-200d).

9. The method as claimed in claim 1, wherein the group of UEs (200a-200d) has same ZC code across the OFDM symbols for the SRS when the transmission variant is the C-CDM-C-CS variant or V-CDM-C-CS variant.

10. The method as claimed in claim 1, wherein the group of UEs (200a-200d) has same ZC code in at least one OFDM symbol but varies across the plurality of OFDM symbols for the SRS when the transmission variant is the C-CDM-V-CS variant.

11. The method as claimed in claim 1, wherein XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with a CDM unique to that subgroup that is same across all the SRS subcarriers; wherein each UE of the subgroup is assigned with one of the Y CS/ZC codes that is same across all OFDM symbols such that the UEs in the subgroup have an unique CS/ZC from the Y ZC/CS codes; wherein the code assignment corresponds to the C-CDM-C-CS variant.

12. The method as claimed in claim 1, wherein the XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with the CDM unique to that subgroup across the given SRS subcarrier; wherein each UE of a subgroup is assigned with one of the Y CS/ZC codes across the plurality of OFDM symbols such that the UEs in a subgroup have an unique CS/ZC from the Y ZC/CS codes; wherein the code assignment corresponds to the V-CDM-C-CS variant.

13. The method as claimed in claim 1, wherein the XY UEs in the group of UEs (200a-200d) are assigned with X CDMs and Y CS/ZC codes; wherein the group of UEs (200a-200d) is divided into X subgroups of Y UEs each; wherein the Y UEs in each subgroup is assigned with the CDM unique to that subgroup that is constant across all SRS subcarriers; wherein each UE of the subgroup is assigned with one of the Y CS/ZC codes for the given OFDM symbol such that the UEs in the subgroup have an unique CS/ZC from the Y ZC/CS codes for that given OFDM symbol; wherein the code assignment corresponds to the C-CDM-V-CS variant.

14. A base station (100) for managing sounding reference signal (SRS) transmission in a wireless communication, wherein the method comprises:
a memory (110);
a processor (120) coupled to the memory (110); and
a communicator (130) coupled to the memory (110) and the processor (120), the processor (120) is configured to:
receive the SRS transmitted from a group of user equipments (UEs) (200a-200d) in the wireless communication over same time-frequency resource, wherein the SRS is transmitted using a transmission variant; wherein the transmission variant is configured by at least one of a time-frequency resource allocation, a cyclic shift/Zadoff-Chu (ZC) code along the subcarriers in at least one OFDM symbol, a code division multiplexing (CDM) code along the OFDM symbols in at least one subcarrier and a comb offset information across the OFDM symbols;
determine the transmission variant for decoding the SRS, wherein the transmission variant is at least one of a constant CDM across the SRS subcarriers and constant cyclic shift (CS)/ZC code across the OFDM symbols (C-CDM-C-CS) variant, a variable CDM across the SRS subcarriers and constant CS/ZC code across the OFDM symbols (V-CDM-C-CS) variant, or a constant CDM across the SRS subcarriers and variable CS/ZC code across OFDM symbols (C-CDM-V-CS) variant; wherein the CDM for the subcarrier is across a plurality of OFDM symbols, CS/ZC code for the OFDM symbol is across the subcarriers; wherein the SRS subcarriers in any OFDM symbol are mapped to an appropriate comb; and
performing one of:
estimating at least one channel between the UEs (200a-200d) and the base station (100) corresponding to the SRS from each UE of the group of UEs (200a-200d) in the slot using a first receiver when the transmission variant is one of the C-CDM-C-CS variant or the V-CDM-C-CS variant, and
estimating at least one channel between the UEs (200a-200d) and the base station (100) corresponding to the SRS from each UE of the group of UEs (200a-200d) in the slot using a second receiver when the transmission variant is one of the C-CDM-C-CS variant or the C-CDM-V-CS variant.

15. The base station (100) as claimed in claim 14, wherein receive the processor is configured to:
transmit a radio resource control (RRC) message to each of the UE in the group of UEs (200a-200d) for transmission of SRS across the subcarriers and the OFDM symbols in designated slots where the SRS is transmitted by the group of UEs (200a-200d), wherein the RRC message comprises at least one of the time-frequency resource allocation, the CDM code allocation, a CS code allocation, the ZC code allocation, and the comb offset information; and
receive the SRS transmitted from the group of UEs (200a-200d) over the same time-frequency resource across the subcarriers and the OFDM symbols in the designated slots, wherein the SRS is transmitted based on the RRC message.
